(19) United States
(12) Patent Application Publication
(10) Pub. No.: US 2025/0208391 A1
(43) Pub. Date: Jun. 26, 2025

(54) ZOOM LENS, PROJECTION TYPE DISPLAY DEVICE, AND IMAGING APPARATUS

(71) Applicant: FUJIFILM Corporation, Tokyo (JP)

(72) Inventor: Masaru AMANO, Saitama (JP)

(73) Assignee: FUJIFILM Corporation, Tokyo (JP)

(21) Appl. No.: 18/972,525

(22) Filed: Dec. 6, 2024

(30) Foreign Application Priority Data
Dec. 20, 2023 (JP) 2023-214970

(51) Int. Cl. G02B 15/14; G02B 13/16; G02B 15/167

(52) U.S. Cl. CPC G02B 15/1461; G02B 13/16; G02B 15/167

(57) ABSTRACT

A zoom lens consists of a first lens group having a negative refractive power, a second lens group having a positive refractive power, a third lens group having a positive refractive power, a fourth lens group having a negative refractive power, a middle group including one or more lens groups, and a final lens group having a positive refractive power in order from an enlargement side to a reduction side. The first lens group consists of a first A partial group having a negative refractive power, a first B partial group, and a first C partial group in order from the enlargement side to the reduction side. During focusing, a spacing between the first B partial group and an adjacent partial group changes. A spacing between the second lens group and the third lens group at a telephoto end is shorter than that at a wide angle end.

### CROSS-REFERENCE TO RELATED APPLICATIONS

This application claims priority from Japanese Patent Application No. 2023-214970, filed on Dec. 20, 2023, the entire disclosure of which is incorporated herein by reference.

### BACKGROUND

### Technical Field

The present disclosed technology relates to a zoom lens, a projection type display device, and an imaging apparatus.

### Related Art

JP2016-095395A and JP2015-212753A below describe an optical system applicable to an image projection apparatus.

### SUMMARY

A zoom lens has been desired where a variation in aberrations is satisfactorily suppressed during changing magnification and during focusing and a high optical performance is exhibited while having a wide angle, a high zoom ratio, and a compact configuration. A level of the demand has increased year by year.

The present disclosure provides a zoom lens where a variation in aberrations is satisfactorily suppressed during changing magnification and during focusing and a high optical performance is exhibited while having a wide angle, a high zoom ratio, and a compact configuration, a projection type display device including the zoom lens, and an imaging apparatus including the zoom lens.

According to one aspect of the present disclosure, there is provided a zoom lens consisting of a first lens group having a negative refractive power, a second lens group having a positive refractive power, a third lens group having a positive refractive power, a fourth lens group having a negative refractive power, a middle group including one or more lens groups, and a final lens group having a positive refractive power in order from an enlargement side to a reduction side, in which the first lens group consists of a first A partial group having a negative refractive power, a first B partial group, and a first C partial group in order from the enlargement side to the reduction side, during focusing, a spacing between the first A partial group and the first B partial group changes and a spacing between the first B partial group and the first C partial group changes, during changing magnification, the first lens group and the final lens group do not move and the second lens group, the third lens group, the fourth lens group, and all the lens groups in the middle group move along an optical axis while changing spacings in an optical axis direction between adjacent lens groups, and a spacing between the second lens group and the third lens group at a telephoto end is shorter than a spacing between the second lens group and the third lens group at a wide angle end.

In the zoom lens according to the above-described aspect, in a case where a spacing between the second lens group and the third lens group at the telephoto end is represented by D23t and a spacing between the second lens group and the third lens group at the wide angle end is represented by D23w,
it is preferable that Conditional Expression (1) represented by

$$D 23 t / D 23 w < 1 \qquad ( 1 )$$

is satisfied.

In the zoom lens according to the above-described aspect, in a case where a combined lateral magnification of the second lens group and the third lens group at the telephoto end is represented by β23t and a combined lateral magnification of the second lens group and the third lens group at the wide angle end is represented by β23w,
it is preferable that Conditional Expression (2) represented by

$$1.4 < β 23 t / β 23 w < 3 \qquad ( 2 )$$

is satisfied.

In the zoom lens according to the above-described aspect, in a case where a focal length of the fourth lens group is represented by fG4 and a focal length of the zoom lens at the wide angle end is represented by fw,
it is preferable that Conditional Expression (3) represented by

$$- 15 < fG 4 / fw < - 1 \qquad ( 3 )$$

is satisfied.

In the zoom lens according to the above-described aspect, in a case where a focal length of the first A partial group is represented by fG1A and a focal length of the first C partial group is represented by fG1C,
it is preferable that Conditional Expression (4) represented by

$$- 0.5 < fG 1 A / fG 1 C < 0.5 \qquad ( 4 )$$

is satisfied.

In the zoom lens according to the above-described aspect, in a case where a focal length of the first A partial group is represented by fG1A and a focal length of the first B partial group is represented by fG1B,
it is preferable that Conditional Expression (5) represented by

$$0 < \vert fG 1 A / fG 1 B \vert < 0.3 \qquad ( 5 )$$

is satisfied.

In the zoom lens according to the above-described aspect, in a case where a focal length of the first lens group is represented by fG1 and a focal length of the zoom lens at the wide angle end is represented by fw,
it is preferable that Conditional Expression (6) represented by

$$- 4 < fG 1 / {f}_{W} < - 1 \qquad ( 6 )$$

is satisfied.

During focusing, the first C partial group may be configured not to move.

In the zoom lens according to the above-described aspect, in a configuration where the first C partial group includes at least one negative lens, in a case where an average value of Abbe numbers of all negative lenses in the first C partial group with respect to a d line is represented by vave,
it is preferable that Conditional Expression (7) represented by

$$ν ave > 50 \qquad ( 7 )$$

is satisfied.

In the zoom lens according to the above-described aspect, it is preferable that the reduction side is telecentric.

In the zoom lens according to the above-described aspect, in a case where a focal length of the second lens group is represented by fG2 and a focal length of the zoom lens at the wide angle end is represented by fw,
it is preferable that Conditional Expression (8) represented by

$$2 < fG 2 / fw < 10 \qquad ( 8 )$$

is satisfied.

In the zoom lens according to the above-described aspect, in a case where a focal length of the third lens group is represented by fG3 and a focal length of the zoom lens at the wide angle end is represented by fw,
it is preferable that Conditional Expression (9) represented by

$$4 < fG 3 / fw < 12 \qquad ( 9 )$$

is satisfied.

In the zoom lens according to the above-described aspect, in a case where a focal length of the final lens group is represented by fGE and a focal length of the zoom lens at the wide angle end is represented by fw,
it is preferable that Conditional Expression (10) represented by

$$3 < fGE / fw < 8 \qquad ( 10 )$$

is satisfied.

In the zoom lens according to the above-described aspect, in a case where a back focus of the zoom lens on the reduction side in terms of an air conversion distance is represented by Bf and a focal length of the zoom lens at the wide angle end is represented by fw,
it is preferable that Conditional Expression (11) represented by

$$2 < Bf / fw \qquad ( 11 )$$

is satisfied.

It is preferable that the middle group includes, at a position closest to the reduction side, a cemented lens where a negative lens and a positive lens are cemented in order from the enlargement side to the reduction side.

The first C partial group may be configured to consist of a negative lens and a positive lens in order from the enlargement side to the reduction side.

According to another aspect of the present disclosure, there is provided a projection type display device comprising the zoom lens according to the above-described aspect.

According to still another aspect of the present disclosure, there is provided an imaging apparatus comprising the zoom lens according to the above-described aspect.

In the present specification, it should be noted that the terms “consisting of” and “consists of” mean that the lens may include not only the above-described components but also lenses substantially having no refractive powers, optical elements, which are not lenses, such as a stop, a mask, a filter, a cover glass, a planar mirror, and a prism, and mechanism parts such as a lens flange, a lens barrel, an imaging element, and a camera shaking correction mechanism.

The term “group that has a positive refractive power” in the present specification means that the group has a positive refractive power as a whole. Similarly, the term “group that has a negative refractive power” means that the group has a negative refractive power as a whole. The term “lens having a positive refractive power” and the term “positive lens” are synonymous with each other. The term “a lens that has a negative refractive power” and the term “negative lens” are synonymous. In the present specification, “lens group” and “focusing group” are not limited to a configuration consisting of a plurality of lenses, but may consist of only one lens.

A compound aspherical lens (in which a lens (for example, a spherical lens) and an aspherical film formed on the spherical lens are integrally formed and function as one aspherical lens as a whole) is not regarded as a cemented lens, but the compound aspherical lens is regarded as one lens. The sign of the refractive power of the lens including the aspherical surface will be used in terms of the paraxial region unless otherwise specified. The “focal length” used in the conditional expressions is a paraxial focal length. The values used in the conditional expression are values that are obtained with respect to the d line.

The “d line”, “C line”, and “F line” described in the present specification are emission lines, the wavelength of the d line is 587.56 nanometers (nm), the wavelength of the C line is 656.27 nanometers (nm), and the wavelength of the F line is 486.13 nanometers (nm).

According to the present disclosure, it is possible to provide a zoom lens where a variation in aberrations is satisfactorily suppressed during changing magnification and during focusing and a high optical performance is exhibited while having a wide angle, a high zoom ratio, and a compact configuration, a projection type display device including the zoom lens, and an imaging apparatus including the zoom lens.

### BRIEF DESCRIPTION OF THE DRAWINGS

FIG. 1 is a cross-sectional view corresponding to a zoom lens according to Example 1 and showing a configuration and luminous fluxes of a zoom lens according to one embodiment.

FIG. 2 is a cross-sectional view showing a configuration of the zoom lens of FIG. 1 in each of zoom states.

FIG. 3 shows each of aberration diagrams showing the zoom lens according to Example 1 in a state where a projection distance is infinite.

FIG. 4 shows each of aberration diagrams showing the zoom lens according to Example 1 in a state where a projection distance is 1370 millimeters (mm).

FIG. 5 is a cross-sectional view showing a configuration and luminous fluxes of a zoom lens according to Example 2.

FIG. 6 shows each of aberration diagrams showing the zoom lens according to Example 2 in a state where a projection distance is infinite.

FIG. 7 shows each of aberration diagrams showing the zoom lens according to Example 2 in a state where a projection distance is 1370 millimeters (mm).

FIG. 8 is a cross-sectional view showing a configuration and luminous fluxes of a zoom lens according to Example 3.

FIG. 9 shows each of aberration diagrams showing the zoom lens according to Example 3 in a state where a projection distance is infinite.

FIG. 10 shows each of aberration diagrams showing the zoom lens according to Example 3 in a state where a projection distance is 1370 millimeters (mm).

FIG. 11 is a cross-sectional view showing a configuration and luminous fluxes of a zoom lens according to Example 4.

FIG. 12 shows each of aberration diagrams showing the zoom lens according to Example 4 in a state where a projection distance is infinite.

FIG. 13 shows each of aberration diagrams showing the zoom lens according to Example 4 in a state where a projection distance is 1370 millimeters (mm).

FIG. 14 is a cross-sectional view showing a configuration and luminous fluxes of a zoom lens according to Example 5.

FIG. 15 shows each of aberration diagrams showing the zoom lens according to Example 5 in a state where a projection distance is infinite.

FIG. 16 shows each of aberration diagrams showing the zoom lens according to Example 5 in a state where a projection distance is 1370 millimeters (mm).

FIG. 17 is a schematic configuration diagram showing a projection type display device according to an embodiment.

FIG. 18 is a schematic configuration diagram showing a projection type display device according to another embodiment.

FIG. 19 is a schematic configuration diagram showing a projection type display device according to still another embodiment.

FIG. 20 is a perspective view showing a front side of an imaging apparatus according to one embodiment.

FIG. 21 is a perspective view showing a rear side of the imaging apparatus shown in FIG. 20.

### DESCRIPTION OF EMBODIMENTS

Hereinafter, embodiments of the present disclosure will be described with reference to the accompanying drawings.

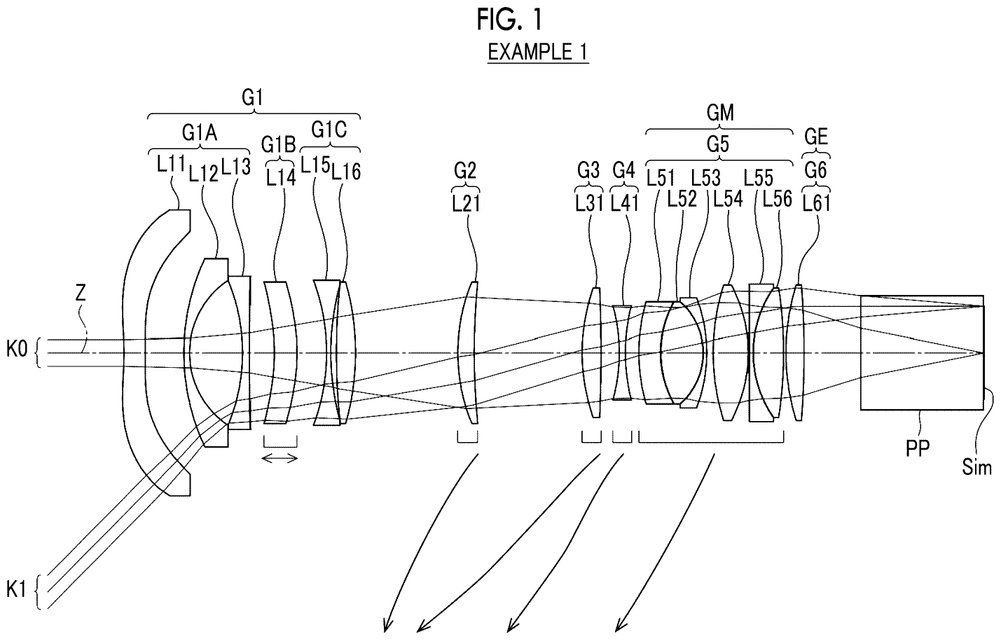

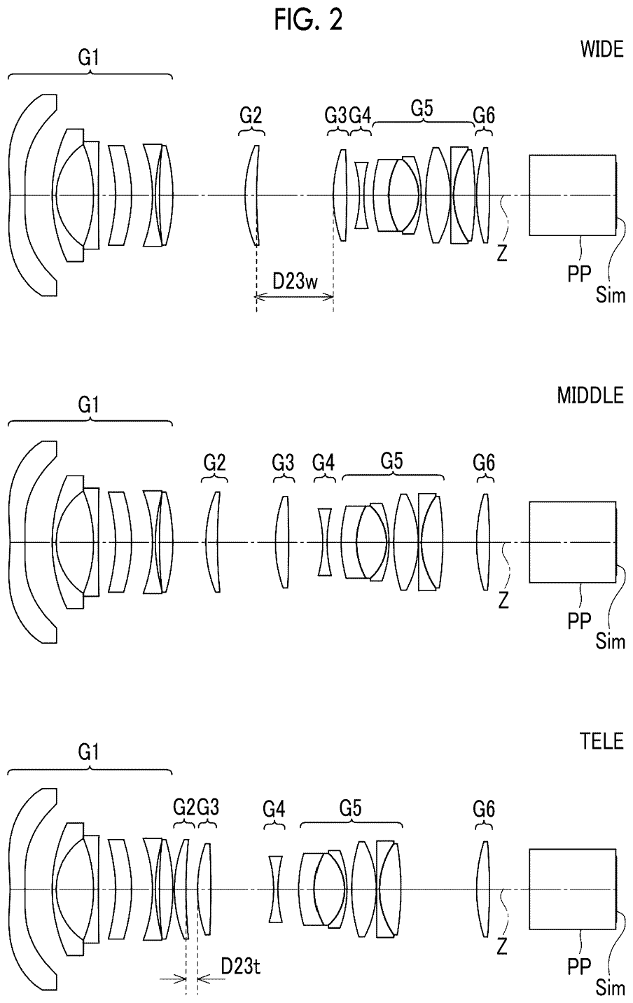

FIG. 1 is a cross-sectional view showing a configuration of a zoom lens according to an embodiment of the present disclosure, and movement loci thereof. FIG. 1 shows, as the luminous flues, on-axis luminous fluxes K0 and luminous fluxes K1 with a maximum half angle of view. In addition, FIG. 2 is a cross-sectional view showing a configuration of the zoom lens of FIG. 1 in each of zoom states. In FIG. 2, the upper stage to which “WIDE” is attached shows a wide angle end state, the middle stage to which “MIDDLE” is attached shows a middle focal length state, and the lower stage to which “TELE” is attached shows a telephoto end state. The configuration example shown in FIGS. 1 and 2 corresponds to Example 1 described below. In FIGS. 1 and 2, the left side is an enlargement side, and the right side is an reduction side. Hereinafter, the description will be described mainly with reference to FIG. 1.

The zoom lens according to the present disclosure may be a projection optical system that is mounted on a projection type display device and forms an image to be projected onto a screen, or may be an imaging optical system that is mounted on an imaging apparatus and forms an image of an object. Hereinafter, the case of using the zoom lens in the application of the projection optical system will be described. Further, hereinafter, “the zoom lens according to the embodiment of the present disclosure” will also be simply referred to as “the zoom lens” in order to avoid redundant description.

FIG. 1 shows an example in which an optical member PP and an image display surface Sim of a light valve are disposed on the reduction side of the zoom lens on the assumption that the zoom lens is mounted on the projection type display device. The optical member PP is a member which is regarded as a filter, a cover glass, a color synthesis prism, or the like. The optical member PP has no refractive power, and a configuration where the optical member PP is not provided can also be adopted. The light valve outputs an optical image, and the optical image is displayed as an image on the image display surface Sim.

In the projection type display device, a luminous flux to which image information is given on the image display surface Sim is incident on the zoom lens through the optical member PP, and is projected onto a screen (not shown) by the zoom lens. In this case, the image display surface Sim corresponds to a reduction-side conjugate plane, and the screen corresponds to an enlargement-side conjugate plane. In the present specification, “the screen” refers to an object onto which a projection image formed by the zoom lens is projected. The screen may be not only a dedicated screen but also a wall surface of a room, a floor surface, a ceiling, an outer wall surface of a building, or the like.

In addition, in the description of the present specification, “the enlargement side” refers to the screen side on the optical path, and the “reduction side” refers to the image display surface Sim side on the optical path. In the present specification, “the enlargement side” and “the reduction side” are determined along the optical path, and this point also applies to a zoom lens having a bent optical path. “Closest to the enlargement side” represents that a position is closest to the enlargement side in the arrangement order on the optical path, and does not represent that the position is closest to the screen in terms of distance. Hereinafter, in order to avoid redundant description, “along the optical path in order from the enlargement side to the reduction side” will also be referred to as “in order from the enlargement side to the reduction side”.

The zoom lens according to the present disclosure consists of a first lens group G1 having a negative refractive power, a second lens group G2 having a positive refractive power, a third lens group G3 having a positive refractive power, a fourth lens group G4 having a negative refractive power, a middle group GM including one or more lens groups, and a final lens group GE having a positive refractive power in order from an enlargement side to a reduction side. By using the group having a negative refractive power as the lens group at a position closest to the enlargement side, the diameter of the lens at the position closest to the enlargement side can be reduced and a sufficient back focus thereof can be ensured, which is advantageous in reducing the size. The second lens group G2 and the third lens group G3 that have a positive refractive power can take a main changing magnification action. The fourth lens group G4 and the middle group GM can act to correct an image plane. In particular, by using the group having a negative refractive power as the fourth lens group G4, an aberration from a wide angle end to a telephoto end that is generated by an increase in the amount of movement of a lens group along with an increase in zoom ratio can be corrected. The middle group GM can be configured with a plurality of groups, which is advantageous in increasing the zoom ratio and the performance. The final lens group GE has a positive refractive power and thus can act for the image formation action and the telecentricity of the reduction side.

During changing magnification, the first lens group G1 and the final lens group GE do not move and the second lens group G2, the third lens group G3, the fourth lens group G4, and all the lens groups in the middle group GM move along an optical axis Z while changing spacings in an optical axis direction between adjacent lens groups. “Not moving ˜ during changing magnification” represents being fixed to a reduction-side conjugate plane during changing magnification. During changing magnification, the first lens group G1 at a position closest to the enlargement side does not move, which is advantageous in suppressing a variation at the center of gravity during changing magnification. During changing magnification, the final lens group GE does not move, which facilitates to ensure the image formation action and the telecentricity of the reduction side.

In the present specification, one lens group is a group of which a spacing to an adjacent group in the optical axis direction changes during changing magnification. During changing magnification, a spacing between adjacent lenses does not change in one lens group. That is, “lens group” is a component part of the zoom lens, and is a part including at least one lens divided by an air spacing that changes during changing magnification. During changing magnification, the lens group units move or are fixed independently of each other. “Lens group” may include components having no refractive power other than the lenses, for example, a stop, a mask, a filter, a cover glass, and a planar mirror.

For example, the zoom lens of FIG. 1 consists of a first lens group G1, a second lens group G2, a third lens group G3, a fourth lens group G4, a fifth lens group G5, and a sixth lens group G6 in order from the enlargement side to the reduction side. In the example of FIG. 1, the middle group GM consists of the fifth lens group G5, and the final lens group GE consists of the sixth lens group G6. In FIG. 1, a schematic movement locus of each of the lens groups during changing magnification from the wide angle end to the telephoto end is indicated by a solid-line arrow below each of the lens groups that move during changing magnification.

For example, each of the groups in FIG. 1 is configured as follows. The first lens group G1 consists of six lenses L11 to L16 in order from the enlargement side to the reduction side. The second lens group G2 consists of one lens L21. The third lens group G3 consists of one lens L31. The fourth lens group G4 consists of one lens L41. The fifth lens group G5 consists of six lenses L51 to L56 in order from the enlargement side to the reduction side. The sixth lens group G6 consists of one lens L61.

The zoom lens of the present disclosure has a configuration where a spacing between the second lens group G2 and the third lens group G3 at the telephoto end is shorter than a spacing between the second lens group G2 and the third lens group G3 at the wide angle end. The spacing between the second lens group G2 and the third lens group G3 that have the main magnification changing action is configured as described above, which is advantageous in suppressing an increase in total lens length and in ensuring a zoom ratio and correcting spherical aberration at the telephoto side while suppressing the diameters of the lenses in the lens groups that move during changing magnification.

In addition, in the zoom lens according to the present disclosure, the first lens group G1 consists of a first A partial group G1A having a negative refractive power, a first B partial group G1B, and a first C partial group G1C in order from the enlargement side to the reduction side. During focusing, a spacing between the first A partial group G1A and the first B partial group G1B changes and a spacing between the first B partial group G1B and the first C partial group G1C changes. That is, in the present disclosure, the partial groups in the first lens group G1 move along the optical axis Z to perform focusing. Hereinafter, the groups that move during focusing will be referred to as a focusing group. By disposing the focusing group in the first lens group G1 that does not move during changing magnification, an operation of separating changing magnification and focusing can be performed. In addition, in the projection optical system, in a case where the projection distance varies along with an increase in angle of view, a change in performance is likely to cause a problem. As in the present disclosure, the first B partial group G1B changes the spacing of the enlargement side and the reduction side adjacent thereto to perform focusing, which is advantageous in suppressing the above-described change in performance in a case where the projection distance varies. In the present specification, “projection distance” refers to the distance on the optical axis from the enlargement-side conjugate plane to the lens surface closest to the enlargement side in the zoom lens.

In the present disclosure, during focusing, only the first B partial group G1B may move, the first A partial group G1A and the first B partial group G1B may move while changing a mutual spacing, the first B partial group G1B and the first C partial group G1C may move while changing a mutual spacing, and the first A partial group G1A, the first B partial group G1B, and the first C partial group G1C may move while changing spacings between adjacent groups. The first B partial group G1B may be a group having a positive refractive power or may be a group having a negative refractive power. The first C partial group G1C may be a group having a positive refractive power or may be a group having a negative refractive power.

For example, in the zoom lens of FIG. 1, the first A partial group G1A consists of lenses L11 to L13, the first B partial group G1B consists of a lens L14, and the first C partial group G1C consists of lenses L15 and L16. In the example of FIG. 1, during focusing, only the first B partial group G1B moves, and the first A partial group G1A and the first C partial group G1C do not move. That is, in the example of FIG. 1, the focusing group consists of the first B partial group G1B. In FIG. 1, a two-way arrow in the left-right direction is added in the focusing group. During focusing, the first C partial group G1C does not move, which can simplify the configuration and can contribute to cost reduction. During focusing, the first A partial group G1A does not move, which can simplify the configuration and can contribute to cost reduction. In addition, the first A partial group G1A having a large lens diameter does not move, which is advantageous in reducing a load on the drive system.

It is preferable that the middle group GM includes, at a position closest to the reduction side, a cemented lens where a negative lens and a positive lens are cemented in order from the enlargement side to the reduction side. In this case, this configuration is advantageous in correcting lateral chromatic aberration, in particular, in correcting lateral chromatic aberration during changing magnification.

In the zoom lens according to the present disclosure, it is preferable that the reduction side is telecentric. For example, a projection type display device that projects a high-definition image mostly employs a so-called three-plate system in which an image display element corresponding to the wavelength of each of the colors of blue, green, and red is provided. In order to support this system, it is preferable that the reduction side is configured to be telecentric. To be exact, in the optical system where the reduction side is configured to be telecentric, a principal ray moving from the surface of the optical system closest to the reduction side to the reduction-side conjugate plane is parallel to the optical axis Z.

However, “the reduction side being telecentric” in the present disclosed technology is not limited to a case where the angle of the above-described principal ray with respect to the optical axis Z is 0 degree, and includes an error that is practically allowed in the technical field to which the present disclosed technology belongs. The error may be, for example, in a range where the angle of the above-described principal ray with respect to the optical axis Z is −3 degrees or more and +3 degrees or less. In a system that does not include an aperture stop, in a case where luminous fluxes are seen in a direction from the enlargement side to the reduction side, the telecentricity may be determined by using, as a substitute for the principal ray, an angle bisector between the maximum luminous flux on the upper side and the maximum luminous flux on the lower side in a cross section of a luminous flux focused on any point on the reduction-side conjugate plane.

Next, preferable configurations relating to conditional expressions of the zoom lens according to the present disclosure will be described. In the following description relating to the conditional expressions, in order to avoid redundant description, factors having the same definition will be represented by the same symbols, and the description thereof will not be repeated.

It is preferable that the zoom lens satisfies Conditional Expression (1). Here, a spacing between the second lens group G2 and the third lens group G3 at the telephoto end is represented by D23t. A spacing between the second lens group G2 and the third lens group G3 at the wide angle end is represented by D23w. For example, FIG. 2 shows the above-described spacings D23t and D23w. In a case where it is attempted to realize a high zoom ratio, an increase in total lens length and an increase the diameters of the lenses in the lens groups that move during changing magnification are likely to occur. However, the corresponding value of Conditional Expression (1) is set not to be the upper limit value or more, which is advantageous in ensuring a high zoom ratio without an increase in total lens length and an increase the diameters of the lenses in the lens groups that move during changing magnification. In addition, in a case where it is attempted to suppress an increase in total lens length, there is likely to be an inconvenience that it is difficult to satisfactorily correct spherical aberration at the telephoto side. By setting the corresponding value of Conditional Expression (1) not to be the upper limit value or more, the above-described inconvenience can be avoided.

$$D 23 t / D 23 w < 1 \qquad ( 1 )$$

It is preferable that the zoom lens satisfies Conditional Expression (1-1). By setting the corresponding value of Conditional Expression (1-1) not to be the lower limit value or less, the third lens group G3 can be set not to be excessively close to the second lens group G2 at the telephoto end. As a result, it is easy to maintain a mechanical holding structure that prevents lenses from coming into contact with each other, or it is easy to maintain a spacing of grooves of cams that hang moving lens groups.

$$0.05 < D 23 t / D 23 w < 1 \qquad ( 1 - 1 )$$

In order to obtain more satisfactory characteristics, the upper limit values of Conditional Expression (1) and Conditional Expression (1-1) are preferably 0.9.

It is preferable that the zoom lens satisfies Conditional Expression (2) below. Here, a combined lateral magnification of the second lens group G2 and the third lens group G3 at the telephoto end is represented by β23t. A combined lateral magnification of the second lens group G2 and the third lens group G3 at the wide angle end is represented by β23w. β23t and β23w are values in a state where the projection distance is infinite. The corresponding value of Conditional Expression (2) is set not to be the lower limit value or less, which is advantageous in ensuring the zoom ratio. More specifically, the corresponding value of Conditional Expression (2) is set not to be the lower limit value or less, which is advantageous in ensuring the zoom ratio while suppressing an increase in total lens length. Conditional Expression (2) represents the size of the magnification changing action of the second lens group G2 and the third lens group G3. In a case where the magnification changing action of the second lens group G2 and the third lens group G3 is excessively large, a large magnification changing action that offsets a part of the magnification changing action is taken by a lens group closer to the reduction side than the third lens group G3. In this case, there is an inconvenience that it is difficult to correct aberrations during changing magnification. By setting the corresponding value of Conditional Expression (2) not to be the upper limit value or more, the magnification changing action of the second lens group G2 and the third lens group G3 is not excessively large, and thus the above-described inconvenience can be avoided, which is advantageous in correcting aberration.

$$1.4 < β 23 t / β23 w < 3 \qquad ( 2 )$$

In order to obtain more satisfactory characteristics, it is more preferable that the lower limit value of Conditional Expression (2) is 1.5. In addition, in order to obtain more satisfactory characteristics, it is more preferable that the upper limit value of Conditional Expression (2) is 2.5.

In a case where a focal length of the fourth lens group G4 is represented by fG4 and a focal length of the zoom lens at the wide angle end is represented by fw, it is preferable that the zoom lens satisfies Conditional Expression (3). fw is a value in a state where the projection distance is infinite. By setting the corresponding value of Conditional Expression (3) not to be the lower limit value or less, the negative refractive power of the fourth lens group G4 is not excessively weak, a high effect of correcting aberrations at the wide angle end and the telephoto end can be obtained, and a sufficiently long back focus can be easily ensured. By not allowing the corresponding value of Conditional Expression (3) to be the upper limit value or more, the negative refractive power of the fourth lens group G4 is not excessively strong, which is advantageous in correcting spherical aberration.

$$- 15 < fG 4 / fw < - 1 \qquad ( 3 )$$

In order to obtain more satisfactory characteristics, it is more preferable that the lower limit value of Conditional Expression (3) is −12. In addition, in order to obtain more satisfactory characteristics, it is more preferable that the upper limit value of Conditional Expression (3) is −1.5.

In a case where a focal length of the first A partial group G1A is represented by fG1A and a focal length of the first C partial group G1C is represented by fG1C, it is preferable that the zoom lens satisfies Conditional Expression (4). By setting the corresponding value of Conditional Expression (4) not to be the lower limit value or less, the positive refractive power of the first C partial group G1C with respect to the first A partial group G1A is not excessively strong, and thus a balance with the refractive power in the first lens group G1 can be easily satisfactorily maintained, which is advantageous in suppressing a change in performance caused by a variation in projection distance. By setting the corresponding value of Conditional Expression (4) not to be the upper limit value or more, the negative refractive power of the first C partial group G1C with respect to the first A partial group G1A is not excessively strong, and thus the negative refractive power required for the first lens group G1 can be maintained without an increase in the diameter of the first A partial group G1A. As a result, this configuration is advantageous in reducing the size.

$$- 0.5 < fG 1 A / fG 1 C < 0.5 \qquad ( 4 )$$

In order to obtain more satisfactory characteristics, it is more preferable that the lower limit value of Conditional Expression (4) is −0.28. In addition, in order to obtain more satisfactory characteristics, it is more preferable that the upper limit value of Conditional Expression (4) is 0.22.

In a case where a focal length of the first B partial group G1B is represented by fG1B, it is preferable that the zoom lens satisfies Conditional Expression (5). The lower limit of Conditional Expression (5) satisfies 0<|fG1A/fG1B| because |fG1A/fG1B| is an absolute value. By setting the corresponding value of Conditional Expression (5) not to be the upper limit value or more, the refractive power of the first B partial group G1B with respect to the first A partial group G1A is not excessively strong, which is advantageous in suppressing a variation in various aberrations caused by a variation in projection distance, in particular, in suppressing a variation in field curvature. As a result, an increase in angle of view and an increase in zoom ratio can be simultaneously facilitated.

$$0 < \vert fG 1 A / fG 1 B \vert < 0.3 \qquad ( 5 )$$

In order to obtain more satisfactory characteristics, it is more preferable that the upper limit value of Conditional Expression (5) is 0.1.

In a case where a focal length of the first lens group G1 is represented by fG1, it is preferable that the zoom lens satisfies Conditional Expression (6). fG1 is a value in a state where the projection distance is infinite. By setting the corresponding value of Conditional Expression (6) not to be the lower limit value or less, the refractive power of the first lens group G1 is not excessively weak. Therefore, a desired back focus can be easily ensured, and thus an increase in total lens length can be suppressed. By setting the corresponding value of Conditional Expression (6) not to be the upper limit value or more, the refractive power of the first lens group G1 is not excessively strong, which is advantageous in correcting distortion and field curvature causing a problem in increasing the angle of view.

$$- 4 < fG 1 / fw < - 1 \qquad ( 6 )$$

In order to obtain more satisfactory characteristics, it is more preferable that the lower limit value of Conditional Expression (6) is −3. In addition, in order to obtain more satisfactory characteristics, it is more preferable that the upper limit value of Conditional Expression (6) is −1.5.

The first C partial group G1C may be configured to include at least one negative lens. In the configuration in which the first C partial group G1C includes at least one negative lens, it is preferable that the zoom lens satisfies Conditional Expression (7). Here, an average value of Abbe numbers of all negative lenses in the first C partial group G1C with respect to the d line is represented by vave. By setting the corresponding value of Conditional Expression (7) not to be the lower limit value or less, which is advantageous in correcting lateral chromatic aberration causing a problem in increasing the angle of view.

$$vave > 50 \qquad ( 7 )$$

In addition, it is preferable that the zoom lens satisfies Conditional Expression (7-1). By setting the corresponding value of Conditional Expression (7-1) not to be the upper limit value or more, an increase in the price of the lens can be suppressed, which is advantageous in reducing the cost.

$$50 < vave < 100 \qquad ( 7 - 1 )$$

In order to obtain more satisfactory characteristics, the lower limit values of Conditional Expression (7) and Conditional Expression (7-1) are preferably 65.

In a case where a focal length of the second lens group G2 is represented by fG2, it is preferable that the zoom lens satisfies Conditional Expression (8). By setting the corresponding value of Conditional Expression (8) not to be the lower limit value or less, the refractive power of the second lens group G2 is not excessively strong, which is advantageous in correcting aberration during changing magnification. By setting the corresponding value of Conditional Expression (8) not to be the upper limit value or more, the amount of movement of the second lens group G2 during changing magnification can be suppressed, which is advantageous in reducing the size.

$$2 < fG 2 / fw < 10 \qquad ( 8 )$$

In order to obtain more satisfactory characteristics, it is more preferable that the lower limit value of Conditional Expression (8) is 4. In addition, in order to obtain more satisfactory characteristics, it is more preferable that the upper limit value of Conditional Expression (8) is 8.

In a case where a focal length of the third lens group G3 is represented by fG3, it is preferable that the zoom lens satisfies Conditional Expression (9). By setting the corresponding value of Conditional Expression (9) not to be the lower limit value or less, the refractive power of the third lens group G3 is not excessively strong, which is advantageous in correcting aberration during changing magnification. By setting the corresponding value of Conditional Expression (9) not to be the upper limit value or more, the amount of movement of the third lens group G3 during changing magnification can be suppressed, which is advantageous in reducing the size.

$$4 < fG 3 / fw < 12 \qquad ( 9 )$$

In order to obtain more satisfactory characteristics, it is more preferable that the lower limit value of Conditional Expression (9) is 5. In addition, in order to obtain more satisfactory characteristics, it is more preferable that the upper limit value of Conditional Expression (9) is 9.

In a case where a focal length of the final lens group GE is represented by fGE, it is preferable that the zoom lens satisfies Conditional Expression (10). By setting the corresponding value of Conditional Expression (10) not to be the lower limit value or less, the refractive power of the final lens group GE is not excessively strong, which is advantageous in maintaining the telecentricity and in ensuring a back focus having an appropriate length. By setting the corresponding value of Conditional Expression (10) not to be the upper limit value or more, the back focus is not excessively long, which is advantageous in reducing the total size of the lens system including the back focus.

$$3 < fGE / fw < 8 \qquad ( 10 )$$

In order to obtain more satisfactory characteristics, it is more preferable that the lower limit value of Conditional Expression (10) is 4. In addition, in order to obtain more satisfactory characteristics, it is more preferable that the upper limit value of Conditional Expression (10) is 7.

In a case where a back focus of the zoom lens on the reduction side in terms of an air conversion distance is represented by Bf, it is preferable that the zoom lens satisfies Conditional Expression (11). Bf is a value in a state where the projection distance is infinite. By setting the corresponding value of Conditional Expression (11) not to be the lower limit value or less, the back focus is not excessively short, which facilitates disposition of a color synthesis prism or the like.

$$2 < Bf / fw \qquad ( 11 )$$

In addition, it is preferable that the zoom lens satisfies Conditional Expression (11-1). By setting the corresponding value of Conditional Expression (11-1) not to be the upper limit value or more, which is advantageous in reducing the total size of the lens system including the back focus.

$$2 < Bf / fw < 8 \qquad ( 11 - 1 )$$

In order to obtain more satisfactory characteristics, the lower limit values of Conditional Expression (11) and Conditional Expression (11-1) are preferably 2.5.

The example shown in FIG. 1 is merely exemplary, and various modifications can be made without departing from the scope of the present disclosed technology.

For example, the first A partial group G1A may be configured to consist of three negative lenses. The first B partial group G1B may be configured to consist of one lens or may be configured to consist of two lenses. In a case where the first B partial group G1B consists of one lens, this lens may be a positive lens or a negative lens. In a case where the first B partial group G1B consists of two lenses, the first B partial group G1B may be configured to consist of, for example, a negative lens and a positive lens. The first C partial group G1C may be configured to consist of a negative lens and a positive lens in order from the enlargement side to the reduction side. The first C partial group G1C is configured as described above, which is advantageous in correcting lateral chromatic aberration.

The focusing group may be configured to consist of one lens or may be configured to consist of two lenses. The number of lenses constituting the focusing group is minimized, which is advantageous in reducing the size and weight of the focusing group.

The second lens group G2 may be configured to consist of one positive lens. The third lens group G3 may be configured to consist of one positive lens. The fourth lens group G4 may be configured to consist of one lens group, may be configured to consist of two lens groups, or may be configured to consist of four lens groups.

The middle group GM may be configured to consist of one lens group or may be configured to consist of two lens groups.

The final lens group GE may be configured to consist of one positive lens.

In order to absorb inclination error and/or position error or the like of an attachment mount to the zoom lens and the projection type display device, a lens closer to the enlargement side than the focusing group may also be configured to be movable as a back adjusting group. For example, in the example of FIG. 1, the lens L14 is the focusing group. However, the lenses L11 to L13 may be configured to be movable as the back adjusting group.

The above-described preferable configurations and available configurations can be freely combined within a range where they do not contradict each other, and it is preferable to appropriately selectively adopt the combination according to required specifications.

For example, one preferable aspect of the zoom lens according to the present disclosure consists of a first lens group G1 having a negative refractive power, a second lens group G2 having a positive refractive power, a third lens group G3 having a positive refractive power, a fourth lens group G4 having a negative refractive power, a middle group GM including one or more lens groups, and a final lens group GE having a positive refractive power in order from an enlargement side to a reduction side, in which the first lens group G1 consists of a first A partial group G1A having a negative refractive power, a first B partial group G1B, and a first C partial group G1C in order from the enlargement side to the reduction side, during focusing, a spacing between the first A partial group G1A and the first B partial group G1B changes and a spacing between the first B partial group G1B and the first C partial group G1C changes, during changing magnification, the first lens group G1 and the final lens group GE do not move and the second lens group G2, the third lens group G3, the fourth lens group G4, and all the lens groups in the middle group GM move along an optical axis Z while changing spacings in an optical axis direction between adjacent lens groups, and a spacing between the second lens group G2 and the third lens group G3 at the telephoto end is shorter than a spacing between the second lens group G2 and the third lens group G3 at the wide angle end.

Next, examples of the zoom lens according to the present disclosure will be described with reference to the drawings. It should be noted that the reference numerals attached to the groups and the lenses in the cross-sectional views of the examples are used independently for the examples in order to avoid the description and the drawings from being complicated by an increase in the number of digits of the reference numerals. Therefore, even in a case where common reference numerals are attached in the drawings of different examples, components do not necessarily have a common configuration.

### Example 1

FIG. 1 is a cross-sectional view showing a configuration and luminous fluxes of a zoom lens according to Example 1 in a state where the projection distance is infinite, and Illustration methods and configurations thereof are the same as described above. Thus, some of repeated description will not be given. For example, the zoom lens according to Example 1 consists of a first lens group G1, a second lens group G2, a third lens group G3, a fourth lens group G4, a fifth lens group G5, and a sixth lens group G6 in order from the enlargement side to the reduction side. The first lens group G1 consists of a first A partial group G1A having a negative refractive power, a first B partial group G1B having a positive refractive power, and a first C partial group G1C having a positive refractive power in order from the enlargement side to the reduction side.

Regarding the zoom lens according to Example 1, Table 1 shows basic lens data, Table 2 shows specifications and variable surface spacings during changing magnification, Table 3 shows aspherical coefficients, and Table 4 shows variable surface spacings during focusing.

The table of the basic lens data is described as follows. The “Sn” column shows surface numbers in a case where the surface closest to the enlargement side is the first surface and the number is increased one by one toward the reduction side. The “R” column shows a curvature radius of each surface. The “D” column shows a surface spacing between each surface and the surface adjacent to the reduction side on the optical axis. The “Nd” column shows a refractive index of each component with respect to the d line. The “vd” column shows an Abbe number of each component with respect to the d line.

In the table of the basic lens data, the sign of the curvature radius of a surface that is convex to the enlargement side is positive, and the sign of the curvature radius of a surface that is convex to the reduction side is negative. The value in the bottom field of the column D in the table indicates a spacing between the image display surface Sim and the surface closest to the reduction side in the table. In the table of basic lens data, the symbol DD[ ] is used for the variable surface spacing during changing magnification, and the surface number of the enlargement-side surface of the spacing is given in [ ] and is shown in the column D. Table 1 shows data in a state where the projection distance is infinite.

Table 2 shows the zoom ratio Zr, the focal length f, the F number F No., and the maximum total angle of view 2ω with respect to the d line. [°] in the fields of 2ω indicates that the unit thereof is a degree. In Table 2, the “WIDE” column shows each of the values at the wide angle end, the “MIDDLE” column shows each of the values in the middle focal length state, and the “TELE” column shows each of the values at the telephoto end.

In the basic lens data, a reference sign * is attached to surface numbers of aspherical surfaces, and values of paraxial curvature radius are shown in the fields of the curvature radius of the aspherical surface. In Table 3, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=3, 4, 5, . . . , and 16. The “E+n” (n: an integer) in the numerical values of the aspherical coefficients of Table 3 indicates “×10^{±n}”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: an aspherical surface depth (a length of a perpendicular from a point on an aspherical surface at a height h to a plane that is perpendicular to the optical axis Z and in contact with the aspherical surface apex),
h: a height (a distance from the optical axis Z to the lens surface),
C: a reciprocal of the paraxial curvature radius, and
KA, Am: aspherical coefficients.
Σ in the aspheric equation represents the total sum regarding m.

Table 4 shows a spacing between the first A partial group G1A and the first B partial group G1B changes and a spacing between the first B partial group G1B and the first C partial group G1C in each of a state where the projection distance is infinite, a state where the projection distance is 1370 millimeters (mm), and a state where the projection distance is 1000 millimeters (mm).

In the data of each of the tables, degrees are used as the unit of an angle, and millimeters are used as the unit of a length. However, appropriate different units may be used because the optical system can be used even in a case where the system is enlarged or reduced in proportion. In addition, each of the following tables shows numerical values rounded off to predetermined decimal places.

TABLE 1
Example 1

| Sn | R | D | Nd | vd |
|---|---|---|---|---|
| *1 | −71.4278 | 5.4151 | 1.53638 | 56.09 |
| *2 | −923.9705 | 9.9413 | | |
| 3 | 56.4401 | 1.4505 | 1.60311 | 60.64 |
| 4 | 22.1826 | 13.5732 | | |
| 5 | −47.5683 | 1.7402 | 1.84666 | 23.78 |
| 6 | 916.7287 | 6.2846 | | |
| *7 | −49.2875 | 5.8009 | 1.53638 | 56.09 |
| *8 | −49.0193 | 7.5758 | | |
| 9 | −52.4507 | 1.1006 | 1.49700 | 81.61 |
| 10 | 65.4053 | 1.4354 | | |
| 11 | 168.8137 | 4.8835 | 1.80610 | 33.27 |
| 12 | −65.3344 | DD[12] | | |
| 13 | 46.9335 | 4.2186 | 1.83400 | 37.21 |
| 14 | 183.4195 | DD[14] | | |
| 15 | 49.7948 | 4.8214 | 1.48749 | 70.44 |
| 16 | −364.3234 | DD[16] | | |
| *17 | −44.8480 | 1.5710 | 1.58313 | 59.46 |
| *18 | 45.8476 | DD[18] | | |
| 19 | 46.8708 | 5.4996 | 1.83481 | 42.74 |
| 20 | 25.7646 | 0.1504 | | |
| 21 | 26.8733 | 10.8263 | 1.51680 | 64.20 |
| 22 | −17.3057 | 0.9000 | 1.90366 | 31.31 |
| 23 | −39.2550 | 1.6835 | | |
| 24 | 57.3118 | 8.9533 | 1.49700 | 81.61 |
| 25 | −36.5941 | 0.1591 | | |
| 26 | ∞ | 0.9998 | 1.87070 | 40.73 |
| 27 | 28.7934 | 7.7694 | 1.49700 | 81.61 |
| 28 | −106.5138 | DD[28] | | |
| 29 | 57.5686 | 4.6451 | 1.72825 | 28.46 |
| 30 | −218.4905 | 14.5650 | | |
| 31 | ∞ | 31.4200 | 1.51680 | 64.20 |
| 32 | ∞ | 0.2143 | | |

TABLE 2
Example 1

| | WIDE | MIDDLE | TELE |
|---|---|---|---|
| Zr | 1.0 | 1.3 | 1.7 |
| f | 11.73 | 15.01 | 19.94 |
| FNo. | 1.71 | 1.86 | 2.07 |
| 2ω[°] | 90.6 | 76.4 | 61.4 |
| DD[12] | 26.24 | 11.98 | 0.57 |
| DD[14] | 27.69 | 21.09 | 4.20 |
| DD[16] | 4.68 | 12.19 | 22.82 |
| DD[18] | 3.47 | 5.12 | 7.52 |
| DD[28] | 0.60 | 12.30 | 27.55 |

TABLE 3

| Example 1 | | | | | | |
|---|---|---|---|---|---|---|
| Sn | 1 | 2 | 7 | 8 | 17 | 18 |
| KA | 6.4936443E−01 | −1.0000008E+01 | 1.0000000E+00 | 1.0000000E+00 | 1.0000000E+00 | 1.0000000E+00 |
| A3 | −1.5164578E−18 | 1.7789954E−17 | 3.5122285E−20 | 5.4851429E−21 | 6.4140674E−22 | −2.7545960E−21 |
| A4 | 4.2563804E−05 | 5.5332947E−05 | 1.0312788E−05 | 6.4363813E−06 | −6.2430471E−06 | −1.1370074E−05 |
| A5 | −1.0595712E−06 | −5.8357750E−06 | 1.2457026E−06 | 7.5634352E−07 | 1.3185884E−07 | 5.3166408E−07 |
| A6 | 3.1937717E−08 | 7.8041924E−07 | −2.5539995E−07 | −8.9865873E−08 | 6.1830659E−08 | 3.3799198E−08 |
| A7 | −6.7450314E−09 | −6.7732669E−08 | 1.3609062E−08 | −2.2930151E−09 | −3.0679335E−10 | −1.5367136E−09 |
| A8 | 3.9807796E−10 | 3.1131104E−09 | 7.7788648E−10 | 6.1039834E−10 | −2.4171478E−10 | −1.1824888E−10 |
| A9 | −5.1422460E−12 | −6.4017144E−11 | −8.9336591E−11 | 1.8522457E−11 | −1.7520844E−12 | −1.5543570E−12 |
| A10 | −2.5719449E−13 | −2.0394022E−13 | −1.1126640E−12 | −3.2109249E−12 | 7.0487774E−13 | 5.7159599E−13 |
| A11 | 7.9429876E−15 | 3.1564882E−14 | 2.7712247E−13 | −1.3328633E−13 | | |
| A12 | 5.2477748E−17 | 6.9827229E−17 | −5.0612815E−16 | 1.3210294E−14 | | |
| A13 | −4.4629691E−18 | −3.4427944E−17 | −5.3158776E−16 | 3.3406970E−16 | | |
| A14 | 2.9517711E−20 | 6.9501329E−19 | 8.5519986E−18 | −2.8155434E−17 | | |
| A15 | 7.7752829E−22 | 3.6019573E−21 | 4.4837558E−19 | −2.8443779E−19 | | |
| A16 | −9.3485027E−24 | −1.6976244E−22 | −1.3337635E−20 | 2.2726500E−20 | | |

TABLE 4
Example 1

| Projection Distance | Infinite | 1370 mm | 1000 mm |
|---|---|---|---|
| Spacing between First | 6.2846 | 8.5913 | 9.4063 |
| A Partial Group and | | | |
| First B Partial Group | | | |
| Spacing between First | 7.5758 | 5.2692 | 4.4541 |
| B Partial Group and | | | |
| First C Partial Group | | | |

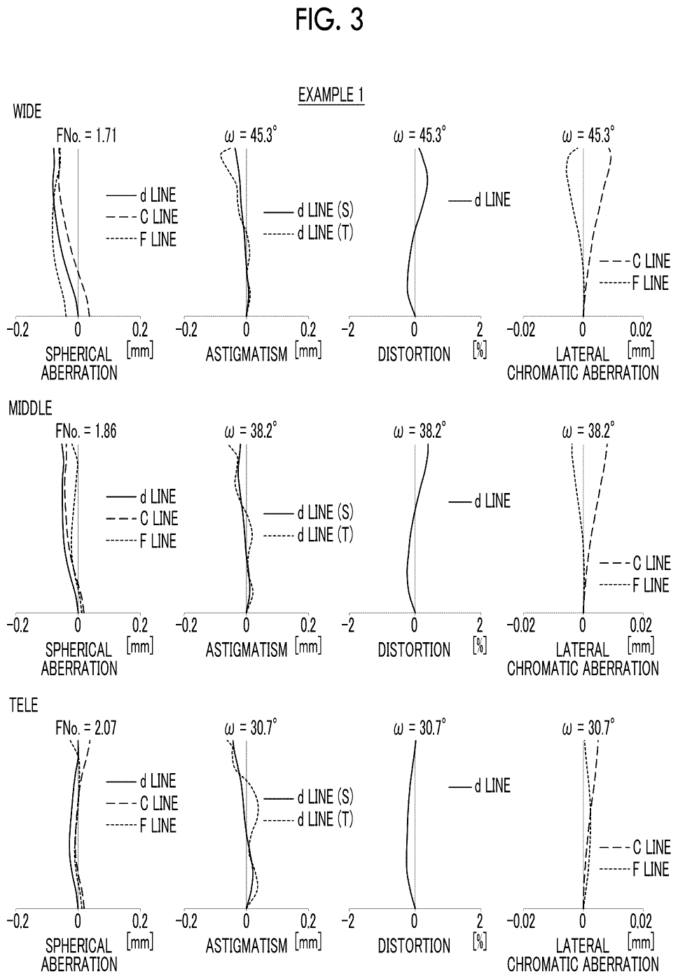

FIG. 3 shows each of aberration diagrams in the zoom lens according to Example 1 in a state where the projection distance is infinite. In FIG. 3, the upper stage to which “WIDE” is attached shows each of aberration diagrams at the wide angle end, the middle stage to which “MIDDLE” is attached shows each of aberration diagrams in the middle focal length state, and the lower stage to which “TELE” is attached shows each of aberration diagrams at the telephoto end. FIG. 3 shows spherical aberration, astigmatism, distortion, and lateral chromatic aberration in order from the left side. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the F number is shown after “F No. =”. In other aberration diagrams, the value of the maximum half angle of view is shown after “ω=”.

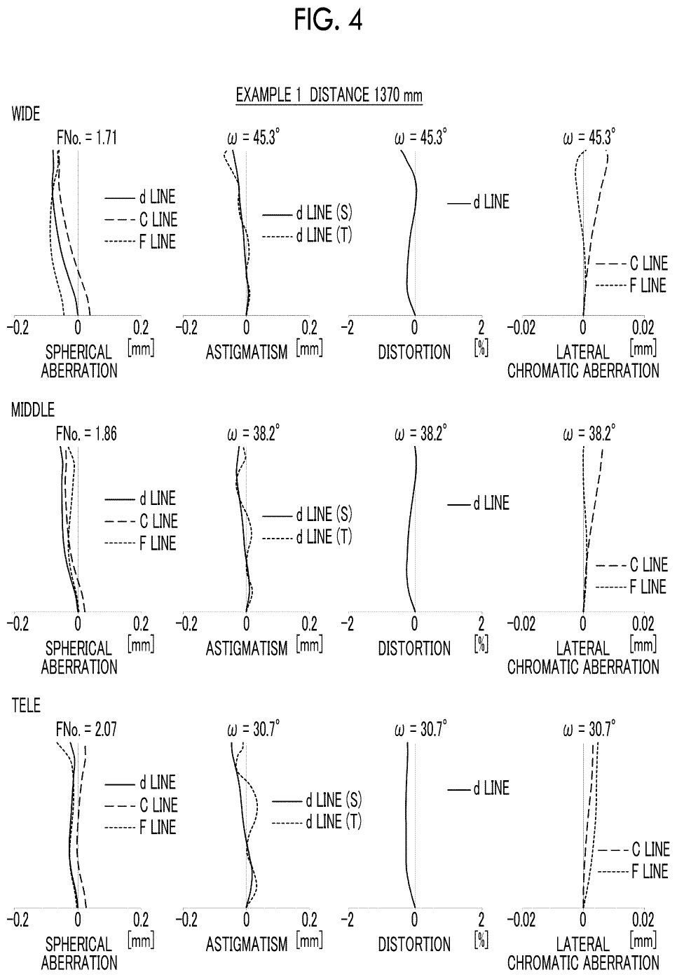

FIG. 4 shows each of aberration diagrams in the zoom lens according to Example 1 in a state where the projection distance is 1370 millimeter (mm). The illustration method of FIG. 4 is the same as that of FIG. 3.

Symbols, meanings, description methods, and illustration methods of the respective data pieces according to Example 1 are basically similar to those in the following examples unless otherwise specified. Therefore, hereinafter, repeated description will not be given.

### Example 2

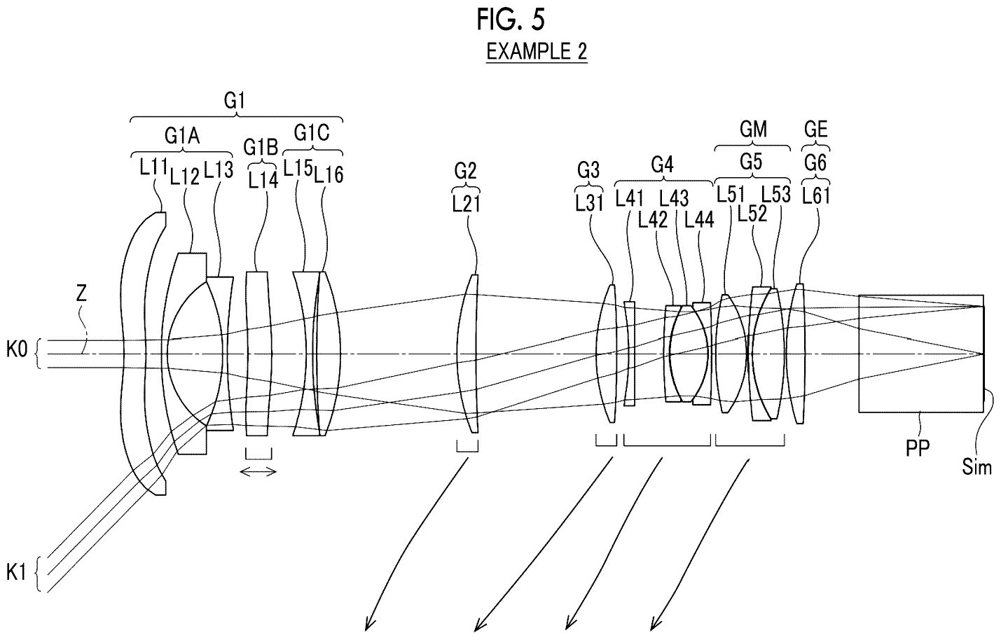

FIG. 5 is a cross-sectional view showing a configuration and luminous fluxes of the zoom lens according to Example 2. For example, the zoom lens according to Example 2 consists of a first lens group G1, a second lens group G2, a third lens group G3, a fourth lens group G4, a fifth lens group G5, and a sixth lens group G6 in order from the enlargement side to the reduction side. The middle group GM consists of the fifth lens group G5, and the final lens group GE consists of the sixth lens group G6. During changing magnification, the first lens group G1 and the sixth lens group G6 do not move and the second lens group G2, the third lens group G3, the fourth lens group G4, and the fifth lens group G5 move along the optical axis Z while changing spacings in an optical axis direction between adjacent lens groups.

The first lens group G1 consists of a first A partial group G1A having a negative refractive power, a first B partial group G1B having a positive refractive power, and a first C partial group G1C having a positive refractive power in order from the enlargement side to the reduction side. The first A partial group GA consists of three lenses L11 to L13 in order from the enlargement side to the reduction side. The first B partial group G1B consists of one lens L14. The first C partial group G1C consists of two lenses L15 and L16 in order from the enlargement side to the reduction side. During focusing, only the first B partial group G1B moves, and the first A partial group G1A and the first C partial group G1C do not move.

The second lens group G2 consists of one lens L21. The third lens group G3 consists of one lens L31. The fourth lens group G4 consists of four lenses L41 to L44 in order from the enlargement side to the reduction side. The fifth lens group G5 consists of three lenses L51 to L53 in order from the enlargement side to the reduction side. The sixth lens group G6 consists of one lens L61.

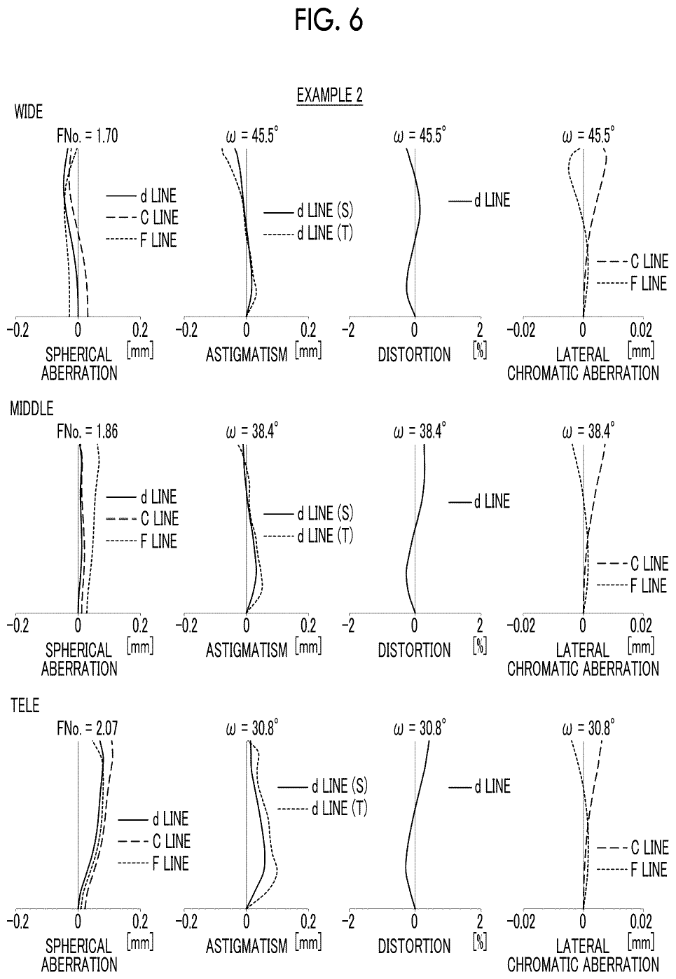

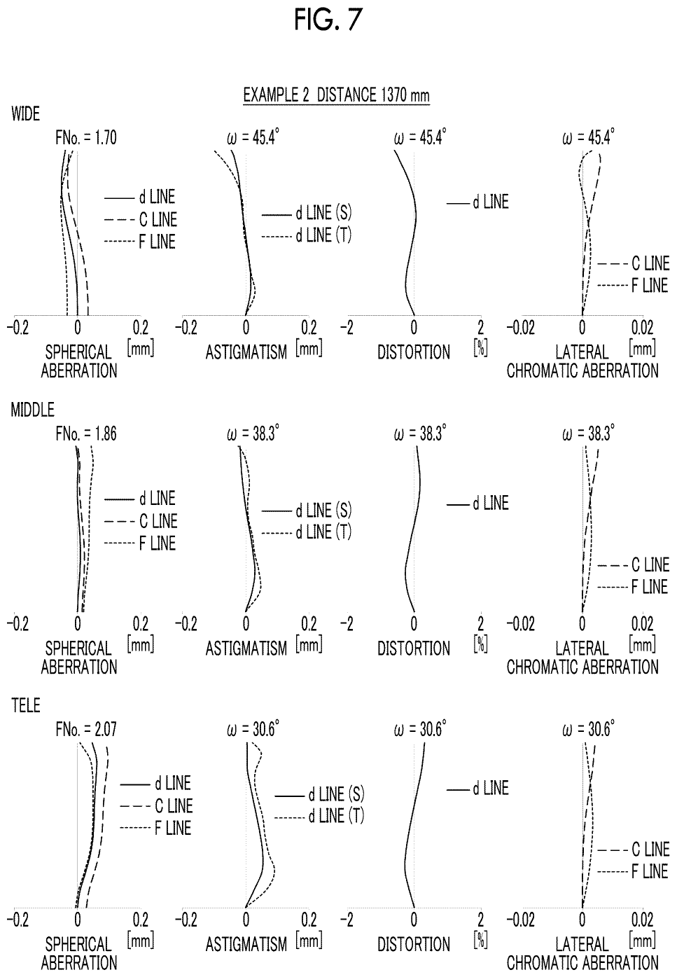

Regarding the zoom lens according to Example 2, Table 5 shows basic lens data, Table 6 shows specifications and variable surface spacings during changing magnification, Table 7 shows aspherical coefficients, and Table 8 shows variable surface spacings during focusing. In addition, in the zoom lens according to Example 2, FIG. 6 shows each of aberration diagrams in a state where the projection distance is infinite, and FIG. 7 shows each of aberration diagrams in a state where the projection distance is 1370 millimeters (mm).

TABLE 5
Example 2

| Sn | R | D | Nd | vd |
|---|---|---|---|---|
| *1 | −44.1127 | 5.4991 | 1.53638 | 56.09 |
| *2 | −64.6296 | 3.9005 | | |
| 3 | 77.1282 | 1.5000 | 1.60311 | 60.64 |
| 4 | 21.5189 | 13.9735 | | |
| 5 | −41.7657 | 1.1991 | 1.84666 | 23.78 |
| 6 | 122.5048 | 5.1644 | | |
| *7 | −109.9004 | 5.8731 | 1.53638 | 56.09 |
| *8 | −93.4962 | 8.6960 | | |
| 9 | −63.3561 | 1.5987 | 1.49700 | 81.61 |
| 10 | 109.3747 | 1.0430 | | |
| 11 | 275.0355 | 6.0090 | 1.80610 | 33.27 |
| 12 | −55.7116 | DD[12] | | |
| 13 | 53.5445 | 4.7987 | 1.83400 | 37.21 |
| 14 | 377.2859 | DD[14] | | |
| 15 | 43.8801 | 5.2210 | 1.48749 | 70.44 |
| 16 | −266.0640 | DD[16] | | |
| *17 | −69.1359 | 1.4991 | 1.85135 | 40.10 |
| *18 | −2479.7917 | 7.3427 | | |
| 19 | 129.3857 | 1.4377 | 1.80400 | 46.53 |
| 20 | 23.2789 | 0.1710 | | |
| 21 | 24.5550 | 9.5156 | 1.48749 | 70.44 |
| 22 | −19.0536 | 0.0810 | | |
| 23 | −18.7295 | 0.8997 | 1.83400 | 37.21 |
| 24 | −263.1609 | DD[24] | | |
| 25 | 66.2413 | 7.7854 | 1.43700 | 95.10 |
| 26 | −25.3598 | 0.3442 | | |
| 27 | 131.4378 | 0.9991 | 1.83481 | 42.74 |
| 28 | 30.8611 | 8.0423 | 1.49700 | 81.61 |
| 29 | −71.6887 | DD[29] | | |
| 30 | 59.3052 | 4.7269 | 1.80610 | 33.27 |
| 31 | −311.1070 | 13.5650 | | |
| 32 | ∞ | 31.4200 | 1.51680 | 64.20 |
| 33 | ∞ | 0.21 | | |

TABLE 6
Example 2

| | WIDE | MIDDLE | TELE |
|---|---|---|---|
| Zr | 1.0 | 1.3 | 1.7 |
| f | 11.66 | 14.93 | 19.83 |
| FNo. | 1.70 | 1.86 | 2.07 |
| 2ω[°] | 91.0 | 76.8 | 61.6 |
| DD[12] | 29.38 | 13.71 | 0.54 |
| DD[14] | 30.30 | 29.04 | 20.72 |
| DD[16] | 2.99 | 7.28 | 14.32 |
| DD [24] | 1.01 | 0.99 | 0.65 |
| DD[29] | 0.52 | 13.17 | 27.97 |

TABLE 7
Example 2

| Sn | 1 | 2 | 7 | 8 | 17 | 18 |
|---|---|---|---|---|---|---|
| KA | 8.4919573E−01 | −1.0000009E+01 | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 | −3.0220639E−07 | 6.3010280E−07 |
| A4 | 7.1237305E−05 | 8.9140188E−05 | 1.6933706E−05 | 1.1639079E−05 | 1.1204202E−08 | 1.2064579E−08 |
| A5 | −2.8778567E−06 | −1.2412667E−05 | −7.3696276E−07 | −6.0830440E−07 | −4.8803850E−11 | −4.3548715E−11 |
| A6 | 3.5804851E−08 | 1.6759493E−06 | −1.5575153E−08 | 3.8391462E−09 | 1.6212684E−13 | 1.6031782E−13 |
| A7 | −3.4021450E−09 | −1.5821118E−07 | 4.1613778E−09 | 2.0577896E−09 | | |
| A8 | 3.1383594E−10 | 8.4597765E−09 | 2.6605610E−10 | 2.5582118E−10 | | |
| A9 | −6.9355252E−12 | −2.0508492E−10 | −5.2870434E−11 | −3.7070559E−11 | | |
| A10 | −1.8119567E−13 | −9.9703149E−13 | 6.0364744E−13 | −1.2580627E−13 | | |
| A11 | 8.0266477E−15 | 1.2660811E−13 | 1.6598555E−13 | 1.2930056E−13 | | |
| A12 | 3.7480927E−17 | 1.5776126E−15 | −3.8025704E−15 | −1.1467845E−15 | | |
| A13 | −4.1066034E−18 | −1.7280766E−16 | −2.3508174E−16 | −1.9955405E−16 | | |
| A14 | 1.4779291E−20 | 2.3630531E−18 | 5.5408446E−18 | 1.9297407E−18 | | |
| A15 | 6.8725526E−22 | 2.1901772E−20 | 1.2746652E−19 | 1.1642005E−19 | | |
| A16 | −3.1530942E−24 | −5.0892306E−22 | −2.3826756E−21 | −6.1879690E−22 | | |

TABLE 8
Example 2

| Projection Distance | Infinite | 1370 mm | 1000 mm |
|---|---|---|---|
| Spacing between First | 5.1644 | 7.0261 | 7.6816 |
| A Partial Group and | | | |
| First B Partial Group | | | |
| Spacing between First | 8.6961 | 6.8343 | 6.1788 |
| B Partial Group and | | | |
| First C Partial Group | | | |

### Example 3

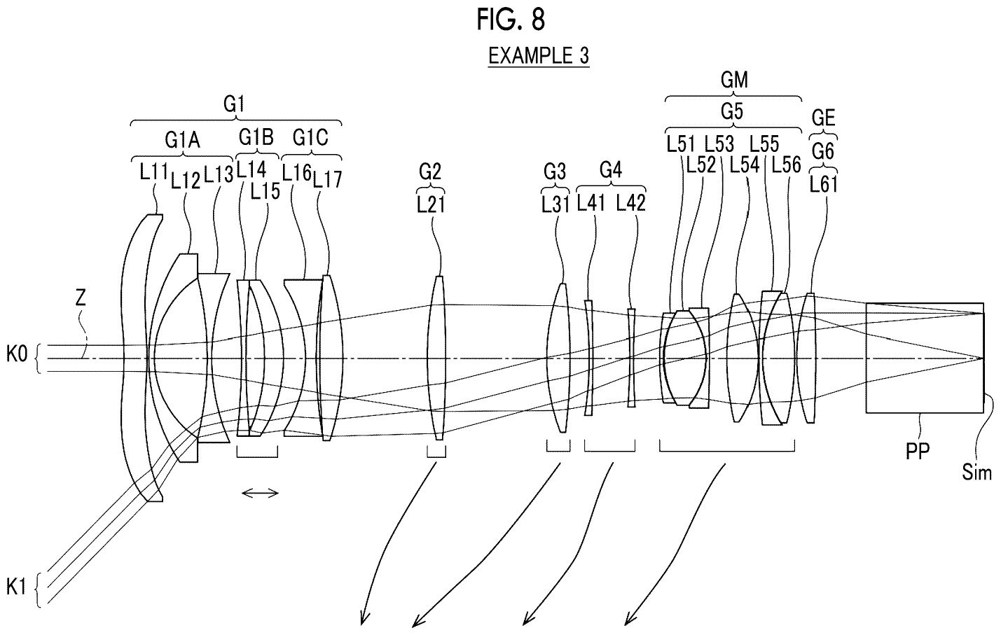

FIG. 8 is a cross-sectional view showing a configuration and luminous fluxes of the zoom lens according to Example 3. For example, the zoom lens according to Example 3 consists of a first lens group G1, a second lens group G2, a third lens group G3, a fourth lens group G4, a fifth lens group G5, and a sixth lens group G6 in order from the enlargement side to the reduction side. The middle group GM consists of the fifth lens group G5, and the final lens group GE consists of the sixth lens group G6. During changing magnification, the first lens group G1 and the sixth lens group G6 do not move and the second lens group G2, the third lens group G3, the fourth lens group G4, and the fifth lens group G5 move along the optical axis Z while changing spacings in an optical axis direction between adjacent lens groups.

The first lens group G1 consists of a first A partial group G1A having a negative refractive power, a first B partial group G1B having a positive refractive power, and a first C partial group G1C having a negative refractive power in order from the enlargement side to the reduction side. The first A partial group G1A consists of three lenses L11 to L13 in order from the enlargement side to the reduction side. The first B partial group G1B consists of two lenses L14 and L15 in order from the enlargement side to the reduction side. The first C partial group G1C consists of two lenses L16 and L17 in order from the enlargement side to the reduction side. During focusing, only the first B partial group G1B moves, and the first A partial group G1A and the first C partial group G1C do not move.

The second lens group G2 consists of one lens L21. The third lens group G3 consists of one lens L31. The fourth lens group G4 consists of four lenses L41 and L42 in order from the enlargement side to the reduction side. The fifth lens group G5 consists of six lenses L51 to L56 in order from the enlargement side to the reduction side. The sixth lens group G6 consists of one lens L61.

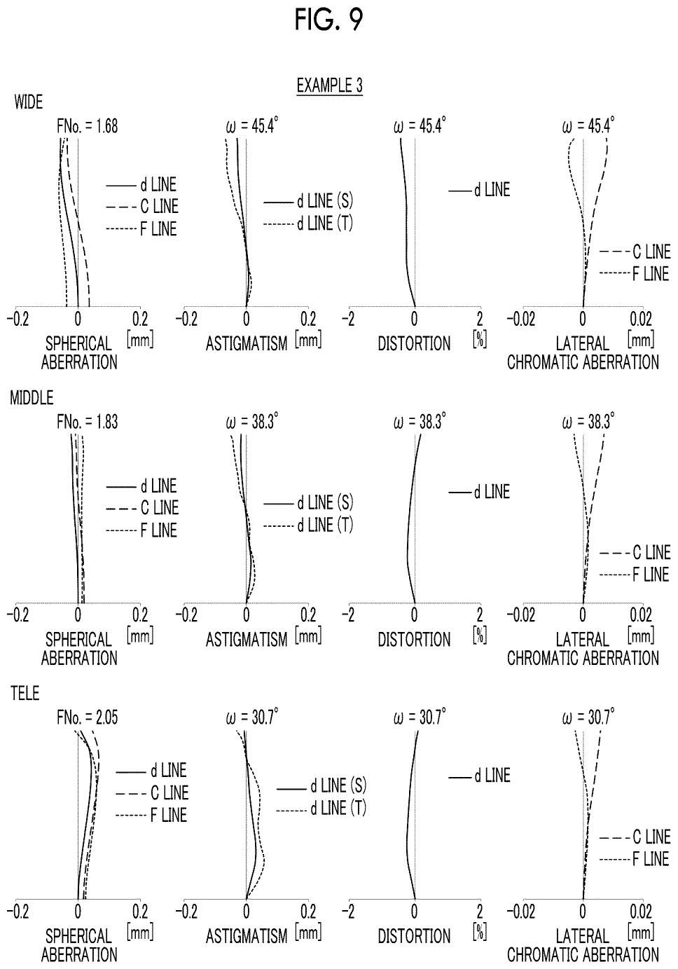

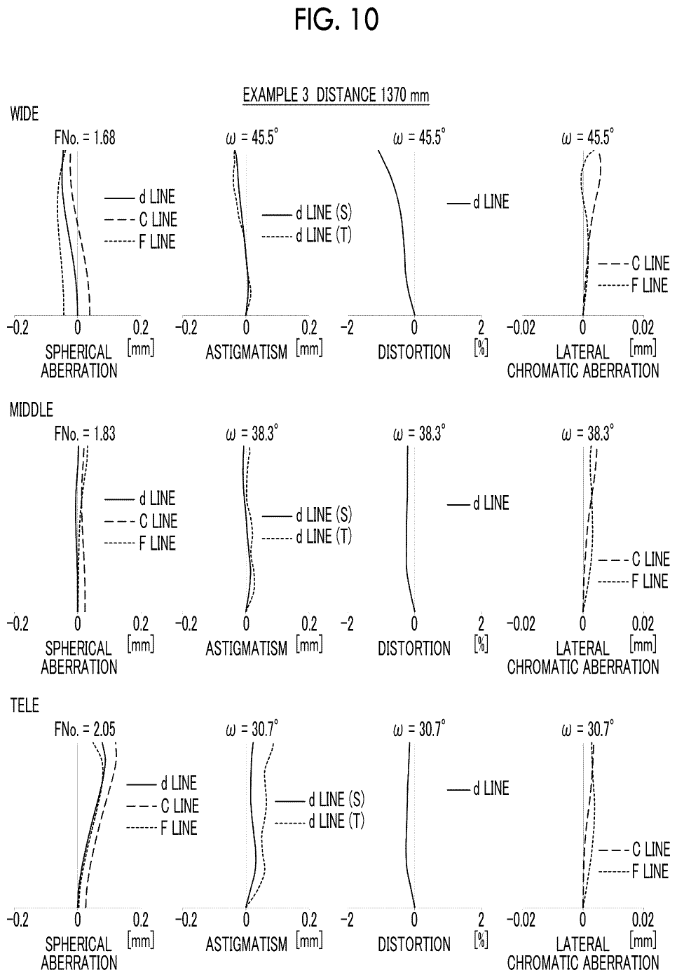

Regarding the zoom lens according to Example 3, Table 9 shows basic lens data, Table 10 shows specifications and variable surface spacings during changing magnification, Table 11 shows aspherical coefficients, and Table 12 shows variable surface spacings during focusing. In addition, in the zoom lens according to Example 3, FIG. 9 shows each of aberration diagrams in a state where the projection distance is infinite, and FIG. 10 shows each of aberration diagrams in a state where the projection distance is 1370 millimeters (mm).

TABLE 9
Example 3

| Sn | R | D | Nd | vd |
|---|---|---|---|---|
| *1 | −65.7907 | 6.1283 | 1.53638 | 56.09 |
| *2 | −79.9191 | 0.5003 | | |
| 3 | 50.4799 | 1.5008 | 1.71299 | 53.87 |
| 4 | 25.3170 | 14.1654 | | |
| 5 | −89.4843 | 1.2006 | 1.84666 | 23.78 |
| 6 | 54.7942 | 7.9765 | | |
| 7 | −179.6201 | 1.2003 | 1.58913 | 61.13 |
| 8 | 202.4224 | 4.8249 | | |
| 9 | −49.3476 | 5.0822 | 1.80400 | 46.53 |
| 10 | −37.3911 | 5.8839 | | |
| 11 | −35.6278 | 2.8824 | 1.49700 | 81.61 |
| 12 | 124.7118 | 0.9520 | | |
| 13 | 272.9886 | 6.1880 | 1.80610 | 33.27 |
| 14 | −70.9737 | DD[14] | | |
| 15 | 97.3166 | 4.9377 | 1.83400 | 37.16 |
| 16 | −283.3175 | DD[16] | | |
| 17 | 55.1771 | 6.2385 | 1.48749 | 70.44 |
| 18 | −161.8668 | DD[18] | | |
| 19 | −99.2055 | 1.0009 | 1.51680 | 64.20 |
| 20 | −367.4860 | 9.8939 | | |
| 21 | −157.3130 | 0.9991 | 1.51823 | 58.90 |
| 22 | 220.4852 | DD[22] | | |
| 23 | 70.8153 | 1.0008 | 1.80400 | 46.53 |
| 24 | 23.0266 | 0.2136 | | |
| 25 | 24.3910 | 11.2394 | 1.48749 | 70.44 |
| 26 | −19.4395 | 0.9007 | 1.80610 | 33.27 |
| 27 | −349.2469 | 4.6510 | | |
| 28 | 73.5137 | 8.2785 | 1.45650 | 90.27 |
| 29 | −31.0123 | 0.1597 | | |
| 30 | 167.4131 | 1.0003 | 1.83481 | 42.74 |
| 31 | 32.7565 | 8.5733 | 1.49700 | 81.61 |
| 32 | −71.8040 | DD[32] | | |
| 33 | 54.9187 | 5.0844 | 1.73800 | 32.33 |
| 34 | −334.5214 | 13.5650 | | |
| 35 | ∞ | 31.4200 | 1.51680 | 64.20 |
| 36 | ∞ | 0.1700 | | |

TABLE 10
Example 3

| | WIDE | MIDDLE | TELE |
|---|---|---|---|
| Zr | 1.0 | 1.3 | 1.7 |
| f | 11.72 | 15.00 | 19.92 |
| FNo. | 1.68 | 1.83 | 2.05 |
| 2ω[°] | 90.8 | 76.6 | 61.4 |
| DD[14] | 22.62 | 9.26 | 0.60 |
| DD[16] | 27.10 | 23.08 | 5.38 |
| DD[18] | 5.13 | 13.44 | 21.59 |
| DD[22] | 6.99 | 3.41 | 3.92 |
| DD[32] | 0.59 | 13.23 | 30.92 |

TABLE 11
Example 3

| Sn | 1 | 2 |
|---|---|---|
| KA | 1.6172379E+00 | −1.3000001E+02 |
| A3 | 0.0000000E+00 | 0.0000000E+00 |
| A4 | 3.3046957E−05 | 1.1112641E−05 |
| A5 | −1.3513630E−06 | −5.2224010E−06 |
| A6 | 7.8436830E−08 | 1.1146086E−06 |
| A7 | −5.7578962E−09 | −1.0322650E−07 |
| A8 | 1.7377534E−10 | 4.7261693E−09 |
| A9 | 1.4221953E−12 | −8.6723949E−11 |
| A10 | −1.4725355E−13 | −8.8875027E−13 |
| A11 | −2.3935708E−16 | 4.0805455E−14 |
| A12 | 8.6215082E−17 | 1.1045789E−15 |
| A13 | −1.0174392E−19 | −5.7680811E−17 |
| A14 | −2.7620222E−20 | 5.5320996E−19 |
| A15 | −4.2255431E−24 | 5.8132517E−21 |
| A16 | 4.6652975E−24 | −9.5182868E−23 |

TABLE 12
Example 3

| Projection Distance | Infinite | 1370 mm | 1000 mm |
|---|---|---|---|
| Spacing between First | 7.9765 | 9.5101 | 10.0568 |
| A Partial Group and | | | |
| First B Partial Group | | | |
| Spacing between First | 5.8839 | 4.3503 | 3.8036 |
| B Partial Group and | | | |
| First C Partial Group | | | |

### Example 4

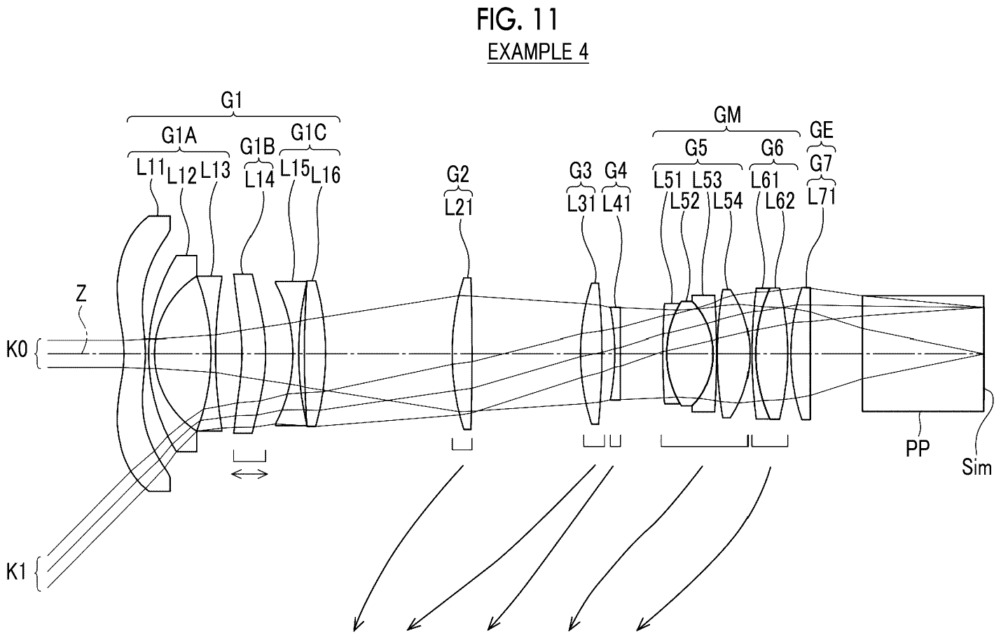

FIG. 11 is a cross-sectional view showing a configuration and luminous fluxes of the zoom lens according to Example 4. For example, the zoom lens according to Example 4 consists of a first lens group G1, a second lens group G2, a third lens group G3, a fourth lens group G4, a fifth lens group G5, a sixth lens group G6, and a seventh lens group G7 in order from the enlargement side to the reduction side. The middle group GM consists of two lens groups that are the fifth lens group G5 and the sixth lens group G6. The final lens group GE consists of the seventh lens group G7. During changing magnification, the first lens group G1 and the seventh lens group G7 do not move and the second lens group G2, the third lens group G3, the fourth lens group G4, the fifth lens group G5, and the sixth lens group G6 move along the optical axis Z while changing spacings in an optical axis direction between adjacent lens groups.

The first lens group G1 consists of a first A partial group G1A having a negative refractive power, a first B partial group G1B having a positive refractive power, and a first C partial group G1C having a negative refractive power in order from the enlargement side to the reduction side. The first A partial group G1A consists of three lenses L11 to L13 in order from the enlargement side to the reduction side. The first B partial group G1B consists of one lens L14. The first C partial group G1C consists of two lenses L15 and L16 in order from the enlargement side to the reduction side. During focusing, only the first B partial group G1B moves, and the first A partial group G1A and the first C partial group G1C do not move.

The second lens group G2 consists of one lens L21. The third lens group G3 consists of one lens L31. The fourth lens group G4 consists of one lens L41. The fifth lens group G5 consists of four lenses L51 to L54 in order from the enlargement side to the reduction side. The sixth lens group G6 consists of two lenses L61 and L62 in order from the enlargement side to the reduction side. The seventh lens group G7 consists of one lens L71.

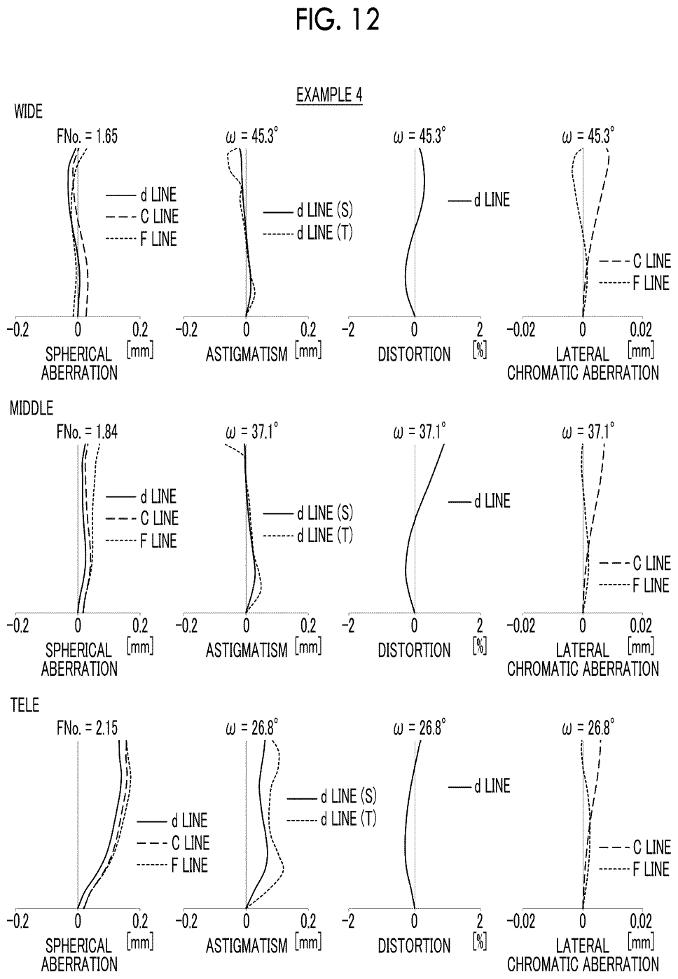

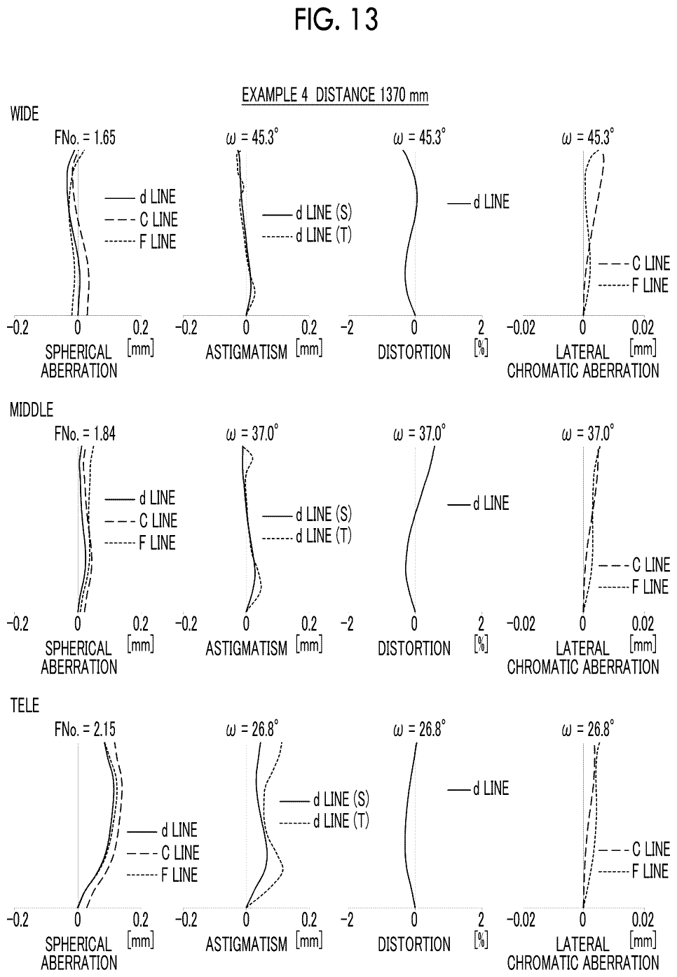

Regarding the zoom lens according to Example 4, Table 13 shows basic lens data, Table 14 shows specifications and variable surface spacings during changing magnification, Table 15 shows aspherical coefficients, and Table 16 shows variable surface spacings during focusing. In addition, in the zoom lens according to Example 4, FIG. 12 shows each of aberration diagrams in a state where the projection distance is infinite, and FIG. 13 shows each of aberration diagrams in a state where the projection distance is 1370 millimeters (mm).

TABLE 13
Example 4

| Sn | R | D | Nd | vd |
|---|---|---|---|---|
| *1 | −27.5118 | 5.5009 | 1.53638 | 56.09 |
| *2 | −38.8149 | 0.8924 | | |
| 3 | 48.1385 | 1.5003 | 1.58913 | 61.13 |
| 4 | 23.6774 | 14.6263 | | |
| 5 | −55.3552 | 1.1991 | 1.84666 | 23.78 |
| 6 | 114.3906 | 6.8281 | | |
| *7 | −51.5441 | 6.0009 | 1.53638 | 56.09 |
| *8 | −43.7030 | 7.0323 | | |
| 9 | −38.8807 | 1.5287 | 1.43700 | 95.10 |
| 10 | 81.1050 | 1.4937 | | |
| 11 | 271.0664 | 5.4599 | 1.78880 | 28.43 |
| 12 | −70.2805 | DD[12] | | |
| 13 | 64.1617 | 5.1501 | 1.83481 | 42.74 |
| 14 | −634.2089 | DD[14] | | |
| 15 | 59.3407 | 5.5227 | 1.48749 | 70.44 |
| 16 | −186.2354 | DD[16] | | |
| *17 | −62.1519 | 1.4991 | 1.85135 | 40.10 |
| *18 | −582.6339 | DD[18] | | |
| 19 | 203.0754 | 0.9991 | 1.83481 | 42.74 |
| 20 | 25.8197 | 12.0190 | 1.49700 | 81.61 |
| 21 | −19.2818 | 0.9000 | 1.72916 | 54.68 |
| 22 | −239.7621 | 0.2004 | | |
| 23 | 98.8785 | 8.3538 | 1.49700 | 81.61 |
| 24 | −29.6481 | DD[24] | | |
| 25 | 130.0450 | 0.9995 | 1.83400 | 37.21 |
| 26 | 40.9841 | 8.2385 | 1.43700 | 95.10 |
| 27 | −68.2020 | DD[27] | | |
| 28 | 52.5840 | 4.9801 | 1.74400 | 44.79 |
| 29 | ∞ | 13.5650 | | |
| 30 | ∞ | 31.4200 | 1.51680 | 64.20 |
| 31 | ∞ | 0.1342 | | |

TABLE 14
Example 4

| | WIDE | MIDDLE | TELE |
|---|---|---|---|
| Zr | 1.0 | 1.3 | 2.0 |
| f | 11.70 | 15.56 | 23.40 |
| FNo. | 1.65 | 1.84 | 2.15 |
| 2ω[°] | 90.6 | 74.2 | 53.6 |
| DD[12] | 32.83 | 16.30 | 0.60 |
| DD[14] | 28.15 | 24.07 | 4.29 |
| DD[16] | 3.33 | 9.84 | 22.29 |
| DD[18] | 10.97 | 7.98 | 8.35 |
| DD[24] | 0.50 | 7.39 | 0.50 |
| DD[27] | 0.84 | 11.04 | 40.59 |

TABLE 15
Example 4

| Sn | 1 | 2 | 7 | 8 | 17 | 18 |
|---|---|---|---|---|---|---|
| KA | −1.4025467E+00 | −1.0000000E+01 | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 | 0.0000000E+00 | 0.0000000E+00 |
| A4 | 7.7917736E−05 | 7.3160795E−05 | 1.5641909E−05 | 1.2704216E−05 | 6.3367805E−06 | 8.6417697E−06 |
| A5 | −1.7883362E−06 | −7.5064124E−06 | 1.0435449E−06 | −7.2236730E−07 | −7.4088783E−07 | −9.2291065E−07 |
| A6 | −1.1122274E−07 | 9.9152606E−07 | −1.8504690E−07 | 1.2274484E−07 | 1.9025540E−08 | 3.0868118E−08 |
| A7 | 1.0703194E−09 | −8.8695294E−08 | 1.0457533E−08 | −8.3900249E−09 | 5.3244708E−10 | 1.3236870E−09 |
| A8 | 3.9050085E−10 | 4.0894824E−09 | 2.3516457E−10 | −2.3373811E−10 | −6.0739091E−13 | −9.1432979E−11 |
| A9 | −1.3259936E−11 | −7.6501242E−11 | −6.1195744E−11 | 5.4902844E−11 | −2.1708094E−13 | −8.0775489E−13 |
| A10 | −1.6500121E−13 | −5.7199142E−13 | 1.4801715E−12 | −7.3016376E−13 | −1.5912104E−15 | 1.7941146E−13 |
| A11 | 1.3373521E−14 | 2.8148712E−14 | 1.2507812E−13 | −1.9267806E−13 | | |
| A12 | −4.8048317E−17 | 8.6680885E−16 | −5.0186965E−15 | 6.6708490E−15 | | |
| A13 | −6.1267822E−18 | −4.2101274E−17 | −1.1764831E−16 | 3.1181752E−16 | | |
| A14 | 6.8271249E−20 | 4.3897024E−19 | 5.7819606E−18 | −1.4916583E−17 | | |
| A15 | 1.0154937E−21 | 3.0537257E−21 | 4.2155913E−20 | −1.8928223E−19 | | |
| A16 | −1.5549882E−23 | −6.8802466E−23 | −2.3426352E−21 | 1.1018974E−20 | | |

TABLE 16
Example 4

| Projection Distance | Infinite | 1370 mm | 1000 mm |
|---|---|---|---|
| Spacing between First | 6.8281 | 8.0654 | 8.5049 |
| A Partial Group and | | | |
| First B Partial Group | | | |
| Spacing between First | 7.0323 | 5.7950 | 5.3555 |
| B Partial Group and | | | |
| First C Partial Group | | | |

### Example 5

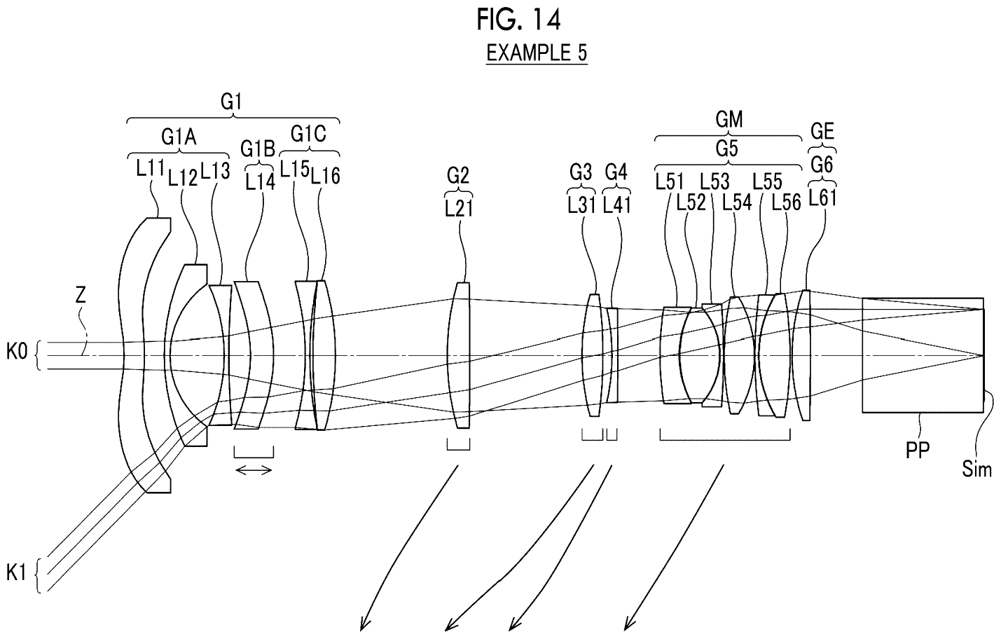

FIG. 14 is a cross-sectional view showing a configuration and luminous fluxes of the zoom lens according to Example 5. For example, the zoom lens according to Example 5 consists of a first lens group G1, a second lens group G2, a third lens group G3, a fourth lens group G4, a fifth lens group G5, and a sixth lens group G6 in order from the enlargement side to the reduction side. The middle group GM consists of the fifth lens group G5, and the final lens group GE consists of the sixth lens group G6. During changing magnification, the first lens group G1 and the sixth lens group G6 do not move and the second lens group G2, the third lens group G3, the fourth lens group G4, and the fifth lens group G5 move along the optical axis Z while changing spacings in an optical axis direction between adjacent lens groups.

The first lens group G1 consists of a first A partial group G1A having a negative refractive power, a first B partial group G1B having a negative refractive power, and a first C partial group G1C having a positive refractive power in order from the enlargement side to the reduction side. The first A partial group G1A consists of three lenses L11 to L13 in order from the enlargement side to the reduction side. The first B partial group G1B consists of one lens L14. The first C partial group G1C consists of two lenses L15 and L16 in order from the enlargement side to the reduction side. During focusing, only the first B partial group G1B moves, and the first A partial group G1A and the first C partial group G1C do not move.

The second lens group G2 consists of one lens L21. The third lens group G3 consists of one lens L31. The fourth lens group G4 consists of one lens L41. The fifth lens group G5 consists of six lenses L51 to L56 in order from the enlargement side to the reduction side. The sixth lens group G6 consists of one lens L61.

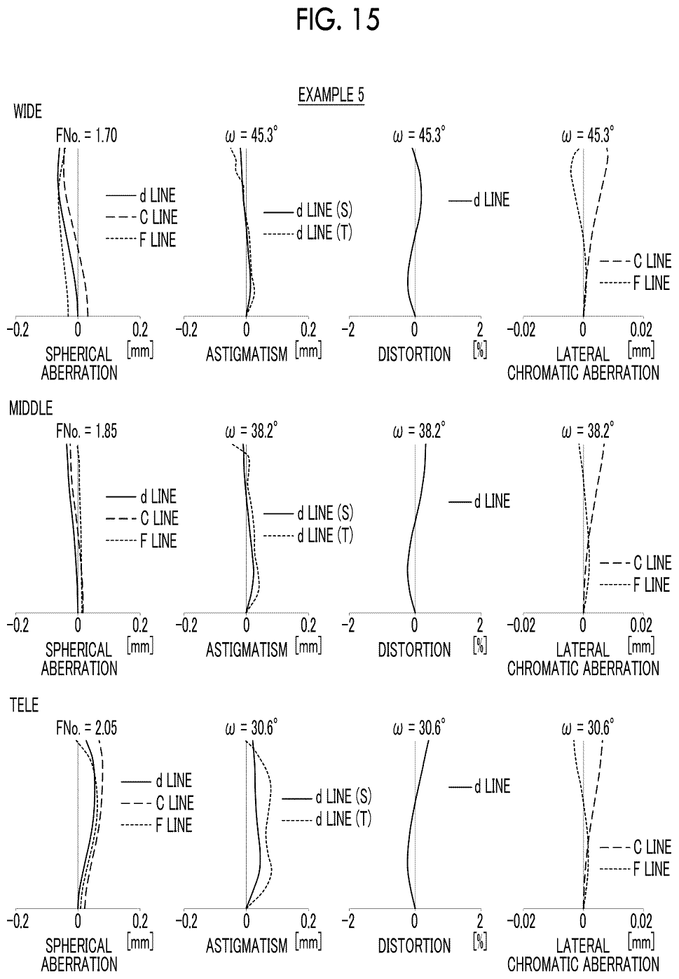

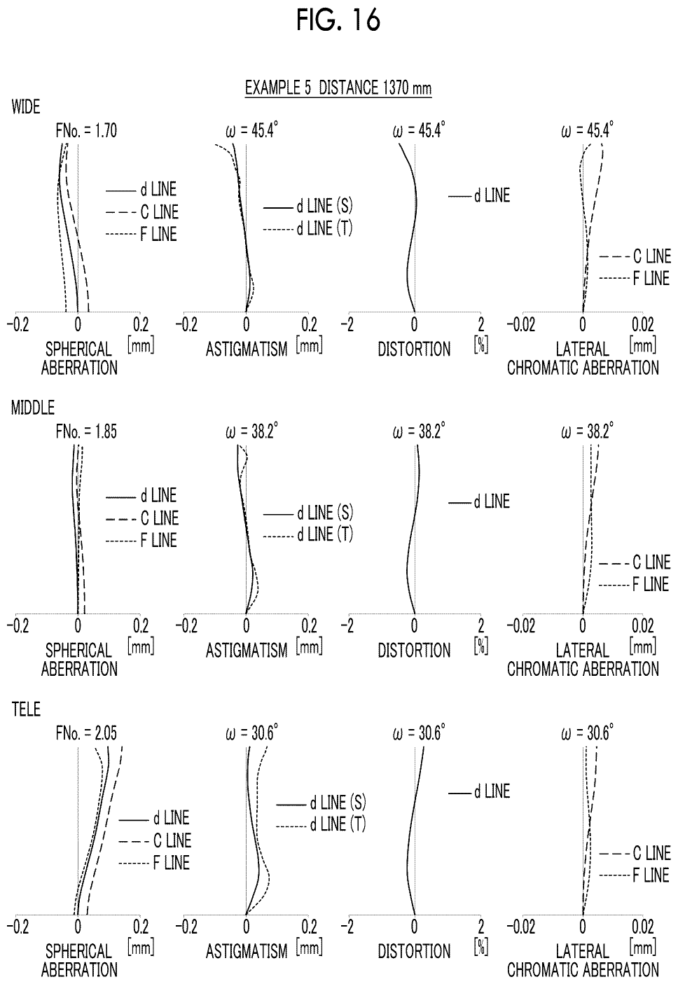

Regarding the zoom lens according to Example 5, Table 17 shows basic lens data, Table 18 shows specifications and variable surface spacings during changing magnification, Table 19 shows aspherical coefficients, and Table 20 shows variable surface spacings during focusing. In addition, in the zoom lens according to Example 5, FIG. 15 shows each of aberration diagrams in a state where the projection distance is infinite, and FIG. 16 shows each of aberration diagrams in a state where the projection distance is 1370 millimeters (mm).

TABLE 17
Example 5

| Sn | R | D | Nd | vd |
|---|---|---|---|---|
| *1 | −30.8985 | 5.3002 | 1.53638 | 56.09 |
| *2 | −48.1080 | 5.1545 | | |
| 3 | 54.5321 | 1.5007 | 1.65160 | 58.54 |
| 4 | 22.3987 | 14.0494 | | |
| 5 | −43.3816 | 1.1999 | 1.84666 | 23.78 |
| 6 | 209.2954 | 5.6429 | | |
| *7 | −34.3323 | 5.9991 | 1.53638 | 56.09 |
| *8 | −38.0471 | 8.2175 | | |
| 9 | −68.3779 | 1.2006 | 1.49700 | 81.61 |
| 10 | 93.8309 | 0.8542 | | |
| 11 | 165.7756 | 5.8035 | 1.80610 | 33.27 |
| 12 | −67.4475 | DD[12] | | |
| 13 | 66.8886 | 5.8614 | 1.83400 | 37.21 |
| 14 | −1518.3842 | DD[14] | | |
| 15 | 60.0400 | 5.4147 | 1.48749 | 70.44 |
| 16 | −119.7209 | DD[16] | | |
| *17 | −56.4298 | 1.4995 | 1.85135 | 40.10 |
| *18 | 8043.8179 | DD[18] | | |
| 19 | 77.5823 | 5.0005 | 1.77250 | 49.60 |
| 20 | 25.0253 | 0.1709 | | |
| 21 | 26.2121 | 10.3556 | 1.48749 | 70.44 |
| 22 | −18.5745 | 0.0806 | | |
| 23 | −18.3402 | 0.8999 | 1.79952 | 42.24 |
| 24 | −177.7311 | 0.2000 | | |
| 25 | 70.2223 | 7.8378 | 1.49700 | 81.61 |
| 26 | −29.4985 | 0.1600 | | |
| 27 | 121.9580 | 1.0000 | 1.83400 | 37.21 |
| 28 | 30.6435 | 8.1316 | 1.43700 | 95.10 |
| 29 | −88.5323 | DD[29] | | |
| 30 | 51.8202 | 4.7437 | 1.80610 | 33.27 |
| 31 | −1195.4826 | 13.5650 | | |
| 32 | ∞ | 31.4200 | 1.51680 | 64.20 |
| 33 | ∞ | 0.2130 | | |

TABLE 18
Example 5

| | WIDE | MIDDLE | TELE |
|---|---|---|---|
| Zr | 1.0 | 1.3 | 1.7 |
| f | 11.72 | 15.00 | 19.92 |
| FNo. | 1.70 | 1.85 | 2.05 |
| 2ω[°] | 90.6 | 76.4 | 61.2 |
| DD[12] | 29.06 | 13.68 | 0.51 |
| DD[14] | 29.03 | 27.42 | 14.40 |
| DD[16] | 2.36 | 7.41 | 15.12 |
| DD[18] | 10.98 | 10.57 | 13.08 |
| DD[29] | 0.50 | 12.84 | 28.80 |

TABLE 19
Example 5

| Sn | 1 | 2 | 7 | 8 | 17 | 18 |
|---|---|---|---|---|---|---|
| KA | −1.9827586E+00 | −1.0000009E+01 | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 | 0.0000000E+00 | 0.0000000E+00 |
| A4 | 7.8899550E−05 | 8.4142505E−05 | 8.3194553E−06 | 6.6221137E−06 | −3.6549799E−06 | −5.4253042E−06 |
| A5 | −2.5748457E−06 | −7.8436610E−06 | 2.5570382E−06 | 8.3415093E−07 | −6.3237048E−08 | −5.6569446E−08 |
| A6 | −7.5661721E−08 | 8.5974054E−07 | −3.9217111E−07 | −9.2512700E−08 | 2.7156596E−08 | 3.6156011E−08 |
| A7 | 2.7157610E−09 | −7.4522854E−08 | 1.2661939E−08 | −2.5668273E−09 | 1.6425360E−10 | −1.4812181E−09 |
| A8 | 2.2281151E−10 | 3.5088528E−09 | 1.8394134E−09 | 8.4361743E−10 | −8.4054135E−11 | −2.1102283E−11 |
| A9 | −1.0461752E−11 | −7.0071904E−11 | −1.4173494E−10 | −1.4763035E−11 | −1.5252706E−13 | 3.0307319E−12 |
| A10 | −3.9277483E−14 | −3.6032902E−13 | −2.1433831E−12 | −2.7562005E−12 | 6.2637043E−14 | −1.6184753E−13 |
| A11 | 8.8665871E−15 | 2.7110038E−14 | 4.1200018E−13 | 6.0822432E−14 | | |
| A12 | −7.2908704E−17 | 5.4643971E−16 | −2.0726041E−15 | 5.8025007E−15 | | |
| A13 | −3.5606585E−18 | −3.4557185E−17 | −5.2790767E−16 | −9.0327259E−17 | | |
| A14 | 5.2558238E−20 | 4.1821827E−19 | 5.9931878E−18 | −7.4132495E−18 | | |
| A15 | 5.2608354E−22 | 2.4871692E−21 | 2.5306543E−19 | 4.8516383E−20 | | |
| A16 | −1.0031874E−23 | −6.6828400E−23 | −3.3852543E−21 | 4.0789282E−21 | | |

TABLE 20
Example 5

| Projection Distance | Infinite | 1370 mm | 1000 mm |
|---|---|---|---|
| Spacing between First | 5.6429 | 8.9154 | 10.1414 |
| A Partial Group and | | | |
| First B Partial Group | | | |
| Spacing between First | 8.2175 | 4.9450 | 3.7190 |
| B Partial Group and | | | |
| First C Partial Group | | | |

Table 21 shows corresponding values of Conditional Expressions (1) to (11) of the zoom lenses according to Examples 1 to 5. Table 21 shows values that are obtained with respect to the d line. Preferable ranges of the conditional expressions may be set by using the corresponding values of the examples shown in Table 21 as the upper limits or the lower limits of the conditional expressions.

TABLE 21

| Expression | | | | | | |
|---|---|---|---|---|---|---|
| No. | | Example 1 | Example 2 | Example 3 | Example 4 | Example 5 |
| (1) | D23t/D23w | 0.15 | 0.68 | 0.20 | 0.15 | 0.50 |
| (2) | β23t/β23w | 1.89 | 1.61 | 1.83 | 2.17 | 1.65 |
| (3) | fG4/fw | −3.29 | −2.11 | −8.81 | −7.00 | −5.59 |
| (4) | fG1A/fG1C | −0.02 | −0.09 | 0.05 | 0.03 | −0.08 |
| (5) | \|fG1A/fG1B\| | 0.01 | 0.02 | 0.01 | 0.05 | 0.01 |
| (6) | fG1/fw | −1.97 | −2.13 | −1.92 | −1.99 | −2.14 |
| (7) | vave | 81.61 | 81.61 | 81.61 | 95.10 | 81.61 |
| (8) | fG2/fw | 6.36 | 6.37 | 7.46 | 5.99 | 6.53 |
| (9) | fG3/fw | 7.69 | 6.66 | 7.27 | 7.95 | 7.05 |
| (10) | fGE/fw | 5.37 | 5.33 | 5.49 | 6.04 | 5.23 |
| (11) | Bf/fw | 3.03 | 2.96 | 2.94 | 2.94 | 2.94 |

Although the zoom lenses according to Examples 1 to 5 are configured to be small, the maximum total angle at the wide angle end is 75 degrees or more, the zoom ratio is 1.4 times or more, and a wide angle and a high zoom ratio are achieved. In the zoom lenses according to Examples 1 to 5, each of the aberrations is satisfactorily corrected, a variation in aberrations during changing magnification and during focusing is satisfactorily suppressed, and a high optical performance is realized.

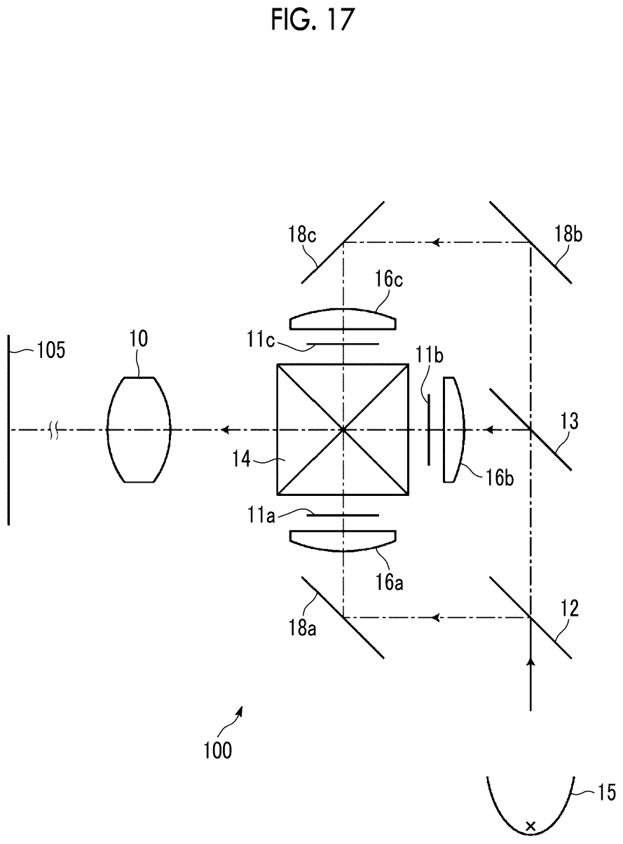

Next, a projection type display device according to an embodiment of the present disclosure will be described. FIG. 17 is a schematic configuration diagram showing the projection type display device according to the embodiment of the present disclosure. A projection type display device 100 shown in FIG. 17 includes a zoom lens 10 according to an embodiment of the present disclosure, a light source 15, and transmissive display elements 11a to 11c as light valves corresponding to colored rays and outputting optical images. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. It should be noted that FIG. 17 schematically shows the zoom lens 10. Further, an integrator is disposed between the light source 15 and the dichroic mirror 12, but is not shown in FIG. 17.

White light emitted from the light source 15 is separated into three colored luminous fluxes (blue light, green light, and red light) through the dichroic mirrors 12 and 13. Next, the three colored luminous fluxes pass through the condenser lenses 16a to 16c, are incident on and modulated by the transmissive display elements 11a to 11c respectively corresponding to the respective colored luminous fluxes, are subjected to color synthesis by the cross dichroic prism 14, and are subsequently incident on the zoom lens 10. The zoom lens 10 projects an optical image based on the modulated light modulated by the transmissive display elements 11a to 11c onto a screen 105.

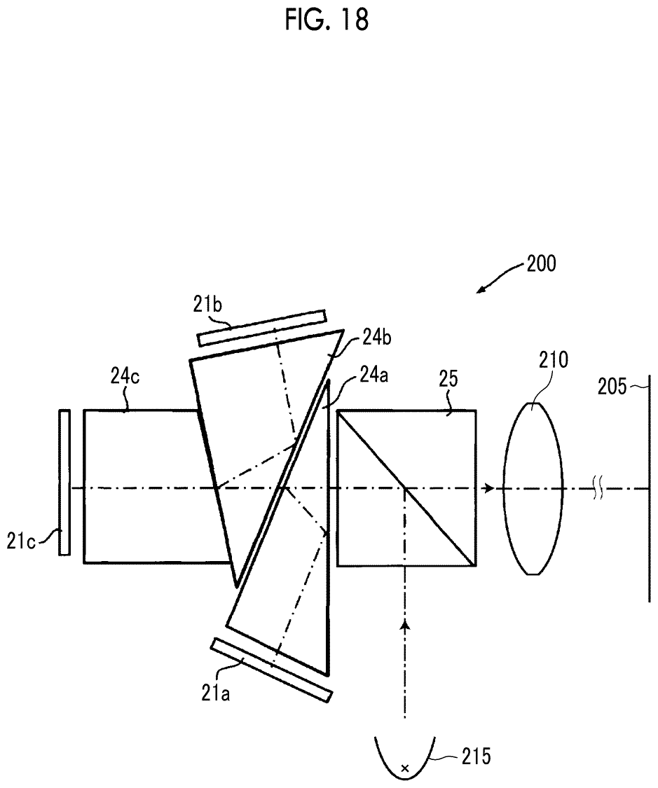

FIG. 18 is a schematic configuration diagram showing a projection type display device according to another embodiment of the present disclosure. A projection type display device 200 shown in FIG. 18 includes a zoom lens 210 according to an embodiment of the present disclosure, a light source 215, and digital micromirror device (DMD: registered trademark) elements 21a to 21c as light valves corresponding to respective colored rays and outputting optical images. Further, the projection type display device 200 includes total internal reflection (TIR) prisms 24a to 24c for color separation and color synthesis, and a polarization separating prism 25 that separates illumination light and projection light. It should be noted that FIG. 18 schematically shows the zoom lens 210. In addition, an integrator is disposed between the light source 215 and the polarization separating prism 25, but is not shown in FIG. 18.

White light emitted from the light source 215 is reflected from a reflecting surface inside the polarization separating prism 25, and is separated into three colored luminous fluxes (blue light, green light, and red light) by the TIR prisms 24a to 24c. The separated colored luminous fluxes are respectively incident on and modulated by the corresponding DMD elements 21a to 21c, travel through the TIR prisms 24a to 24c again in the opposite direction, are subjected to color synthesis, subsequently transmit through the polarization separating prism 25, and are incident on the zoom lens 210. The zoom lens 210 projects an optical image based on the modulated light modulated by the DMD elements 21a to 21c onto a screen 205.

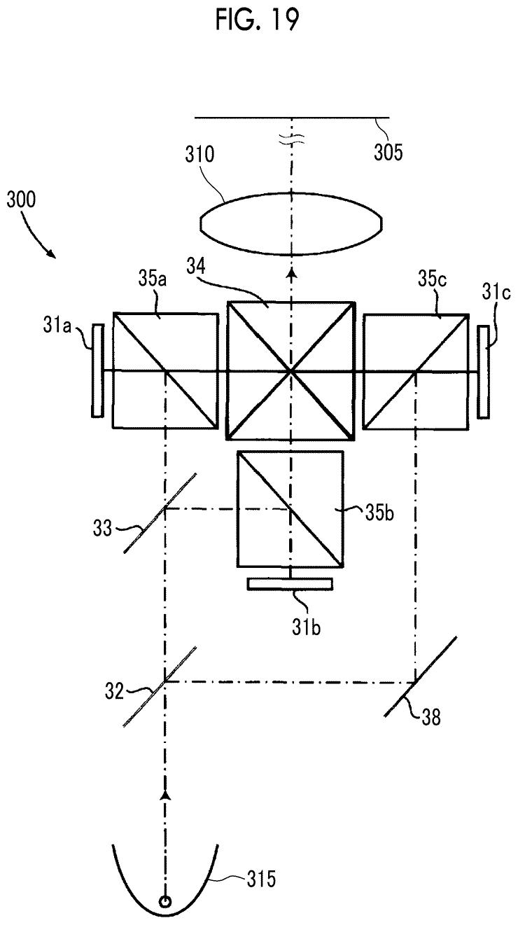

FIG. 19 is a schematic configuration diagram showing a projection type display device according to still another embodiment of the present disclosure. A projection type display device 300 shown in FIG. 19 includes a zoom lens 310 according to an embodiment of the present disclosure, a light source 315, and reflective display elements 31a to 31c as light valves corresponding to colored rays and outputting optical images. In addition, the projection type display device 300 includes dichroic mirrors 32 and 33 for color separation, a cross dichroic prism 34 for color synthesis, a total reflection mirror 38 for optical path deflection, and polarization separating prisms 35a to 35c. It should be noted that FIG. 19 schematically shows the zoom lens 310. Further, an integrator is disposed between the light source 315 and the dichroic mirror 32, but is not shown in FIG. 19.

White light emitted from the light source 315 is separated into three colored luminous fluxes (blue light, green light, and red light) through the dichroic mirrors 32 and 33. The separated colored luminous fluxes respectively pass through the polarization separating prisms 35a to 35c, are respectively incident on and modulated by the corresponding reflective display elements 31a to 31c, are subjected to color synthesis by the cross dichroic prism 34, and are subsequently incident on the zoom lens 310. The zoom lens 310 projects an optical image based on the modulated light modulated by the reflective display elements 31a to 31c onto a screen 305.

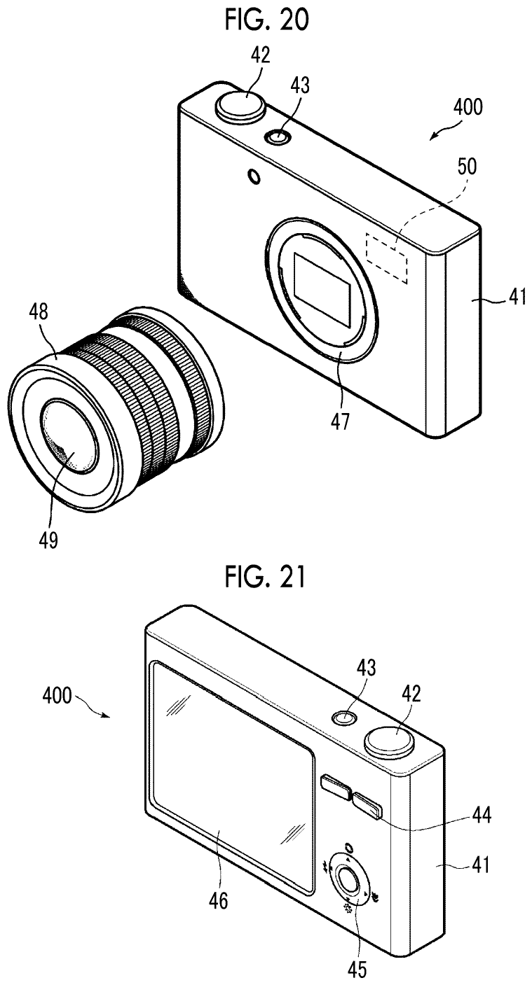

FIGS. 20 and 21 are external views showing a camera 400 that is an imaging apparatus according to an embodiment of the present disclosure. FIG. 20 is a perspective view showing the camera 400 when seen from a front side, and FIG. 21 is a perspective view showing the camera 400 when seen from a rear side. The camera 400 is a mirrorless single-lens type digital camera on which an interchangeable lens 48 is attachably and detachably mounted. The interchangeable lens 48 is a lens barrel containing a zoom lens 49 according to an embodiment of the present disclosure.

The camera 400 includes a camera body 41, and a shutter button 42 and a power button 43 are provided on an upper surface of the camera body 41. Further, an operator 44, an operator 45 and a display unit 46 are provided on the rear surface of the camera body 41. The display unit 46 displays a captured image and an image within an angle of view before imaging.

An imaging aperture through which light from an imaging target is incident is provided at the center on the front surface of the camera body 41. A mount 47 is provided at a position corresponding to the imaging aperture. The interchangeable lens 48 is mounted on the camera body 41 with the mount 47 interposed therebetween.

An imaging element 50 is provided in the camera body 41. The imaging element 50 outputs an imaging signal corresponding to the subject image formed by the interchangeable lens 48. For example, a charge coupled device (CCD) or a complementary metal oxide semiconductor (CMOS) is used as the imaging element 50. A signal processing circuit (not shown), a recording medium (not shown), and the like are provided in the camera body 41. The signal processing circuit processes the imaging signal output from the imaging element 50 to generate an image. The recording medium is used to record the generated image. The camera 400 captures a still image or a motion picture by pressing the shutter button 42, and records image data obtained through imaging in the recording medium.

The present disclosed technology has been hitherto described through the embodiments and the examples, but the present disclosed technology is not limited to the above-described embodiments and examples, and may be modified into various forms. For example, the curvature radius, the surface spacing, the refractive index, the Abbe number, the aspherical coefficient, and the like of each of the lenses are not limited to the values shown in the examples, and different values may be used therefor.

Further, the projection type display device according to the present disclosed technology is not limited to the above-described configuration, and may be modified into various forms such as the optical member used for luminous flux separation or luminous flux synthesis and the light valve. The light valve is not limited to a form in which light emitted from the light source is spatially modulated by an image display element and is output as an optical image based on image data, but may be a form in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and may be modified into various forms such as a non-mirrorless type camera, a film camera, a video camera, a security camera, and a camera for movie imaging.

Regarding the above-described embodiments and examples, the following supplementary notes will be further disclosed.

### Supplementary Note 1

A zoom lens consisting of a first lens group having a negative refractive power, a second lens group having a positive refractive power, a third lens group having a positive refractive power, a fourth lens group having a negative refractive power, a middle group including one or more lens groups, and a final lens group having a positive refractive power in order from an enlargement side to a reduction side,
in which the first lens group consists of a first A partial group having a negative refractive power, a first B partial group, and a first C partial group in order from the enlargement side to the reduction side,
during focusing, a spacing between the first A partial group and the first B partial group changes and a spacing between the first B partial group and the first C partial group changes,
during changing magnification, the first lens group and the final lens group do not move and the second lens group, the third lens group, the fourth lens group, and all the lens groups in the middle group move along an optical axis while changing spacings in an optical axis direction between adjacent lens groups, and
a spacing between the second lens group and the third lens group at a telephoto end is shorter than a spacing between the second lens group and the third lens group at a wide angle end.

### Supplementary Note 2

The zoom lens according to Supplementary Note 1,
in which in a case where a spacing between the second lens group and the third lens group at the telephoto end is represented by D23t and
a spacing between the second lens group and the third lens group at the wide angle end is represented by D23w,
Conditional Expression (1) represented by

$$D 23 t / D 23 w < 1 \qquad ( 1 )$$

is satisfied.

### Supplementary Note 3

The zoom lens according to Supplementary Note 1 or 2,
in which in a case where a combined lateral magnification of the second lens group and the third lens group at the telephoto end is represented by β23t and
a combined lateral magnification of the second lens group and the third lens group at the wide angle end is represented by β23w,
Conditional Expression (2) represented by

$$1.4 < β 23 t / β 23 w < 3 \qquad ( 2 )$$

is satisfied.

### Supplementary Note 4

The zoom lens according to any one of Supplementary Notes 1 to 3,
in which in a case where a focal length of the fourth lens group is represented by fG4 and
a focal length of the zoom lens at the wide angle end is represented by fw,
Conditional Expression (3) represented by

$$- 15 < fG 4 / fw < - 1 \qquad ( 3 )$$

is satisfied.

### Supplementary Note 5

The zoom lens according to any one of Supplementary Notes 1 to 4,
in which in a case where a focal length of the first A partial group is represented by fG1A and
a focal length of the first C partial group is represented by fG1C,
Conditional Expression (4) represented by

$$- 0.5 < fG 1 A / fG 1 C < 0.5 \qquad ( 4 )$$

is satisfied.

### Supplementary Note 6

The zoom lens according to any one of Supplementary Notes 1 to 5,
in which in a case where a focal length of the first A partial group is represented by fG1A and
a focal length of the first B partial group is represented by fG1B,
Conditional Expression (5) represented by

$$0 < \vert fG 1 A / fG 1 B \vert < 0.3 \qquad ( 5 )$$

is satisfied.

### Supplementary Note 7

The zoom lens according to any one of Supplementary Notes 1 to 6,
in which in a case where a focal length of the first lens group is represented by fG1 and
a focal length of the zoom lens at the wide angle end is represented by fw,
Conditional Expression (6) represented by

$$- 4 < fG 1 / fw < - 1 \qquad ( 6 )$$

is satisfied.

### Supplementary Note 8

The zoom lens according to any one of Supplementary Notes 1 to 7,
in which during focusing, the first C partial group does not move.

### Supplementary Note 9

The zoom lens according to any one of Supplementary Notes 1 to 8,
in which in a case where the first C partial group includes at least one negative lens and
an average value of Abbe numbers of all negative lenses in the first C partial group with respect to a d line is represented by vave,
Conditional Expression (7) represented by

$$vave > 50 \qquad ( 7 )$$

is satisfied.

### Supplementary Note 10

The zoom lens according to any one of Supplementary Notes 1 to 9,
in which the reduction side is telecentric.

### Supplementary Note 11

The zoom lens according to any one of Supplementary Notes 1 to 10,
in which in a case where a focal length of the second lens group is represented by fG2 and
a focal length of the zoom lens at the wide angle end is represented by fw,
Conditional Expression (8) represented by

$$2 < fG 2 / fw < 10 \qquad ( 8 )$$

is satisfied.

### Supplementary Note 12

The zoom lens according to any one of Supplementary Notes 1 to 11,
in which in a case where a focal length of the third lens group is represented by fG3 and
a focal length of the zoom lens at the wide angle end is represented by fw,
Conditional Expression (9) represented by

$$4 < fG 3 / fw < 12 \qquad ( 9 )$$

is satisfied.

### Supplementary Note 13

The zoom lens according to any one of Supplementary Notes 1 to 12,
in which in a case where a focal length of the final lens group is represented by fGE and
a focal length of the zoom lens at the wide angle end is represented by fw,
Conditional Expression (10) represented by

$$3 < fGE / fw < 8 \qquad ( 10 )$$

is satisfied.

### Supplementary Note 14

The zoom lens according to any one of Supplementary Notes 1 to 13,
in which in a case where a back focus of the zoom lens on the reduction side in terms of an air conversion distance is represented by Bf and
a focal length of the zoom lens at the wide angle end is represented by fw,
Conditional Expression (11) represented by

$$2 < Bf / fw \qquad ( 11 )$$

is satisfied.

### Supplementary Note 15

The zoom lens according to any one of Supplementary Notes 1 to 14,
in which the middle group includes, at a position closest to the reduction side, a cemented lens where a negative lens and a positive lens are cemented in order from the enlargement side to the reduction side.

### Supplementary Note 16

The zoom lens according to any one of Supplementary Notes 1 to 15,
in which the first C partial group consists of a negative lens and a positive lens in order from the enlargement side to the reduction side.

### Supplementary Note 17

A projection type display device comprising:
the zoom lens according to any one of Supplementary Notes 1 to 16.

### Supplementary Note 18

An imaging apparatus comprising:
the zoom lens according to any one of Supplementary Notes 1 to 16.

What is claimed is:

1. A zoom lens consisting of a first lens group having a negative refractive power, a second lens group having a positive refractive power, a third lens group having a positive refractive power, a fourth lens group having a negative refractive power, a middle group including one or more lens groups, and a final lens group having a positive refractive power in order from an enlargement side to a reduction side,
wherein the first lens group consists of a first A partial group having a negative refractive power, a first B partial group, and a first C partial group in order from the enlargement side to the reduction side,
during focusing, a spacing between the first A partial group and the first B partial group changes and a spacing between the first B partial group and the first C partial group changes,
during changing magnification, the first lens group and the final lens group do not move and the second lens group, the third lens group, the fourth lens group, and all the lens groups in the middle group move along an optical axis while changing spacings in an optical axis direction between adjacent lens groups, and
a spacing between the second lens group and the third lens group at a telephoto end is shorter than a spacing between the second lens group and the third lens group at a wide angle end.

2. The zoom lens according to claim 1,
wherein in a case where a spacing between the second lens group and the third lens group at the telephoto end is represented by D23t and
a spacing between the second lens group and the third lens group at the wide angle end is represented by D23w,
Conditional Expression (1) represented by
$$D 23 t / D 23 w < 1 \qquad ( 1 )$$
is satisfied.

3. The zoom lens according to claim 1,
wherein in a case where a combined lateral magnification of the second lens group and the third lens group at the telephoto end is represented by β23t and
a combined lateral magnification of the second lens group and the third lens group at the wide angle end is represented by β23w,
Conditional Expression (2) represented by
$$1.4 < β 23 t / β 23 w < 3 \qquad ( 2 )$$
is satisfied.

4. The zoom lens according to claim 1,
wherein in a case where a focal length of the fourth lens group is represented by fG4 and
a focal length of the zoom lens at the wide angle end is represented by fw,
Conditional Expression (3) represented by
$$- 15 < fG 4 / fw < - 1 \qquad ( 3 )$$
is satisfied.

5. The zoom lens according to claim 1,
wherein in a case where a focal length of the first A partial group is represented by fG1A and
a focal length of the first C partial group is represented by fG1C,
Conditional Expression (4) represented by
$$- 0.5 < fG 1 A / fG 1 C < 0.5 \qquad ( 4 )$$
is satisfied.

6. The zoom lens according to claim 1,
wherein in a case where a focal length of the first A partial group is represented by fG1A and
a focal length of the first B partial group is represented by fG1B,
Conditional Expression (5) represented by
$$0 < \vert fG 1 A / fG 1 B \vert < 0.3 \qquad ( 5 )$$
is satisfied.

7. The zoom lens according to claim 1,
wherein in a case where a focal length of the first lens group is represented by fG1 and
a focal length of the zoom lens at the wide angle end is represented by fw,
Conditional Expression (6) represented by
$$- 4 < fG 1 / fw < - 1 \qquad ( 6 )$$
is satisfied.

8. The zoom lens according to claim 1,
wherein during focusing, the first C partial group does not move.

9. The zoom lens according to claim 1,
wherein in a case where the first C partial group includes at least one negative lens and
an average value of Abbe numbers of all negative lenses in the first C partial group with respect to a d line is represented by vave,
Conditional Expression (7) represented by
$$vave > 50 \qquad ( 7 )$$
is satisfied.

10. The zoom lens according to claim 1,
wherein the reduction side is telecentric.

11. The zoom lens according to claim 1,
wherein in a case where a focal length of the second lens group is represented by fG2 and
a focal length of the zoom lens at the wide angle end is represented by fw,
Conditional Expression (8) represented by
$$2 < fG 2 / fw < 10 \qquad ( 8 )$$
is satisfied.

12. The zoom lens according to claim 1,
wherein in a case where a focal length of the third lens group is represented by fG3 and
a focal length of the zoom lens at the wide angle end is represented by fw,
Conditional Expression (9) represented by
$$4 < fG 3 / fw < 12 \qquad ( 9 )$$
is satisfied.

13. The zoom lens according to claim 1,
wherein in a case where a focal length of the final lens group is represented by fGE and
a focal length of the zoom lens at the wide angle end is represented by fw,
Conditional Expression (10) represented by
$$3 < fGE / fw < 8 \qquad ( 10 )$$
is satisfied.

14. The zoom lens according to claim 1,
wherein in a case where a back focus of the zoom lens on the reduction side in terms of an air conversion distance is represented by Bf and
a focal length of the zoom lens at the wide angle end is represented by fw,
Conditional Expression (11) represented by
$$2 < Bf / fw \qquad ( 11 )$$
is satisfied.

15. The zoom lens according to claim 1,
wherein the middle group includes, at a position closest to the reduction side, a cemented lens where a negative lens and a positive lens are cemented in order from the enlargement side to the reduction side.

16. The zoom lens according to claim 1,
wherein the first C partial group consists of a negative lens and a positive lens in order from the enlargement side to the reduction side.

17. A projection type display device comprising:
the zoom lens according to claim 1.

18. An imaging apparatus comprising:
the zoom lens according to claim 1.
